(19) United States
(12) Patent Application Publication
(10) Pub. No.: US 2025/0134740 A1
(43) Pub. Date: May 1, 2025

(54) Apparatus and Methods for Repositioning a Person

(71) Applicants: Paul Lapstun, Collaroy (AU); Stephen Douglas Beed, Halifax (CA); Awdah Arraf, Toronto (CA); Vincent Cyprien Castonguay-Siu, Montreal (CA)

(72) Inventors: Paul Lapstun, Collaroy (AU); Stephen Douglas Beed, Halifax (CA); Awdah Arraf, Toronto (CA); Vincent Cyprien Castonguay-Siu, Montreal (CA)

(21) Appl. No.: 18/606,728

(22) Filed: Mar. 15, 2024

Related U.S. Application Data
(60) Provisional application No. 63/460,614, filed on Apr. 20, 2023.
(60) Provisional application No. 63/465,859, filed on May 11, 2023.
(60) Provisional application No. 63/466,325, filed on May 14, 2023.
(60) Provisional application No. 63/469,529, filed on May 29, 2023.
(60) Provisional application No. 63/471,244, filed on Jun. 5, 2023.
(60) Provisional application No. 63/522,129, filed on Jun. 20, 2023.
(60) Provisional application No. 63/543,447, filed on Oct. 10, 2023.

(51) Int. Cl. A61G 7/10

(52) U.S. Cl. CPC A61G 7/1055; A61G 7/1015; A61G 7/1034; A61G 7/1046; A61G 7/1051

(57) ABSTRACT

An apparatus for supporting a person in a recumbent position and for repositioning the person, the apparatus comprising a platform for supporting the person, a wheeled base, and a motorised lift for elevating and repositioning the person, the platform having a longitudinal length sufficient to accommodate a length of the person and a lateral width sufficient to accommodate a width of the person.

### SUMMARY

One embodiment provides an apparatus for supporting a person in a recumbent position and for repositioning the person, the apparatus comprising a platform for supporting the person, a wheeled base, and a motorised lift for elevating and repositioning the person, the platform having a longitudinal length sufficient to accommodate a length of the person and a lateral width sufficient to accommodate a width of the person.

The apparatus may further comprise a frame, a pair of lateral tracks, and a longitudinal track, the frame extending upwards above the platform and coupled to the platform at or near its longitudinal ends, each lateral track coupled to a respective longitudinal end of the frame at or near a top of the frame, each end of the longitudinal track coupled a respective one of the lateral tracks via a trolley running along the lateral track, the lift coupled to the longitudinal track via a longitudinal trolley running along the longitudinal track, thereby allowing the lift to be moved freely both laterally and longitudinally relative to the platform, thereby allowing the person to be elevated using the lift and repositioned both laterally and longitudinally.

The apparatus may further comprise a pair of lateral telescoping slides, each slide coupled to a respective longitudinal end of the frame at or near a top of the frame, each lateral track coupled to a respective slide, each lateral track thus coupled indirectly to the frame, each lateral slide adapted to telescope beyond at least one lateral edge of the platform, thereby allowing the person to be elevated using the lift and repositioned laterally between the platform and an adjacent support surface.

The apparatus may further comprise a pair of telescoping outriggers, the outriggers adapted to telescope in the same direction as the slides, thereby to prevent the apparatus from tipping when the person is supported by the lift beyond a lateral edge of the platform.

The outriggers may be coupled to the platform and be adapted to at least partially rest on the adjacent surface.

The outriggers may be coupled to the base and be adapted to at least partially rest on a floor.

Each outrigger may comprise a wheel at or near its end.

The apparatus may further comprise a wrap for at least partially wrapping the person and coupling the person to the lift.

The wrap may comprise a first piece of flexible sheet-like material, the wrap adapted to be coupled to the lift via a plurality of straps connected along both of its lateral edges, and to support the person when elevated using the lift.

The wrap may comprise a first piece of flexible sheet-like material and a second piece of flexible sheet-like material, the two pieces coupled to each other along both lateral sides of the person, the wrap adapted to be coupled to the lift via a plurality of straps connected along one of its lateral sides, and to support the person when elevated using the lift.

The apparatus may further comprise at least one elevator, the platform coupled to the base via the at least one elevator, the at least one elevator adapted to allow the height of the platform relative to the base to be varied.

The frame may comprise four vertical posts and two lateral horizontal bars, each post coupled to the platform at or near a respective corner of the platform, each lateral bar coupled to a pair of posts at or near a top of the posts at a respective longitudinal end if the frame.

The two posts at a head end of the platform may be separated approximately by the width of the platform, but are inset along a bottom part of their height to allow one or more tubes connected to the person to be routed outside a respective one of the posts while allowing the one or more tubes to be routed inside a corresponding lateral edge of the platform.

The frame may further comprise two longitudinal horizontal bars, each longitudinal bar coupled to a pair of the posts at or near a top of the posts along a respective lateral side of the frame.

Another embodiment provides a method, using the apparatus and one-piece wrap, for repositioning the person from the platform to the adjacent surface, the method comprising the steps of: placing the first wrap piece on the platform; placing the person on top of the wrap piece; coupling both lateral edges of the wrap to the lift using straps; elevating the person using the lift; moving the suspended person to the adjacent surface; lowering the person onto the adjacent surface using the lift; and decoupling the wrap from the lift.

Another embodiment provides a method, using the apparatus and two-piece wrap, for repositioning the person from the platform to the adjacent surface, the method comprising the steps of: placing the first wrap piece on the platform; placing the person on top of the wrap piece; placing the second wrap piece on top of the person; coupling the two wrap pieces together, thus at least partially cocooning the person; coupling one lateral side of the wrap to the lift using straps; elevating the person using the lift, thus simultaneously rotating the person approximately 90 degrees about a longitudinal axis of the person; moving the suspended person to the adjacent surface; lowering the person onto the adjacent surface using the lift, simultaneously rotating the person another approximately 90 degrees about their longitudinal axis; decoupling the wrap from the lift; decoupling the two wrap pieces from each other; and removing the first wrap piece.

Another embodiment provides a two-part wrap for wrapping a person and elevating the person using an overhead lift, the wrap comprising a back wrap part and a front wrap part, each wrap part attachable to the other via a closure along each of its lateral edges.

The wrap may extend from the shoulders of the person to below the knees of the person.

The wrap may extend from above the head of the person to below the feet of the person, providing support for the entire body of the person.

Each closure may be adjustable, to ensure a snug fit of the wrap to the person.

Each closure may incorporate one or more fasteners, including a hook-and-loop fastener, a strap-and-buckle fastener, a zipper fastener, and any combination thereof.

Each wrap part may incorporate two or more connection points coincident with or adjacent to each closure.

An attachment strap may connect at a first end to an attachment point, and at a second end to the overhead lift, either directly, or to an intermediate hook or t-bar, or to an additional intermediate support bar.

Each wrap part may incorporate two or more handles coincident with or adjacent to each closure, the handles facilitating manual handling of the wrapped person.

Each wrap part may comprise an air-assisted low-friction transfer device, and be attachable to an air supply to supply air to the device.

Each wrap part may comprise an air-assisted alternating pressure device, and be attachable to an air supply to supply air to the device.

Each wrap part may comprise an air-assisted microclimate management device, and be attachable to an air supply to supply air to the device.

Each wrap part may comprise one or more inflatable bladders for ensuring a snug fit, and be attachable to an air supply to supply air to the bladders.

Each wrap part may comprise one or more inflatable bladders to provide rigidity when the wrapper person is suspended, and be attachable to an air supply to supply air to the bladders.

Each wrap part may comprise one or more rigid parts to provide rigidity when the wrapper person is suspended.

Each rigid part may be hinged to allow the wrap part to be folded.

Another embodiment provides a method for turning a person on a bed between a supine position and a prone position using a wrap and a lift, the method including the steps of wrapping the person in the wrap, attaching a lateral side of the wrap to the lift, lifting the supine/prone wrapped person above the bed using the lift, moving the suspended person laterally above the bed using the lift, lowering the person onto the bed using the lift into a prone/supine position, and unwrapping the person.

The method may include removing the wrap from under the person.

The wrap may be a two-part wrap, and the method may include leaving one part of the wrap under the person.

Another embodiment provides a method for laterally transferring a person between a first bed and a second bed using a wrap and a lift, the method including the steps of placing the wrap under the person, attaching both lateral sides of the wrap to the lift, lifting the person above the first bed using the lift, moving the suspended person laterally to above the second bed using the lift, lowering the person onto the second bed using the lift, detaching the wrap from the lift.

The method may include removing the wrap from under the person.

The wrap may be one part of a two-part wrap.

Another embodiment provides a method for laterally transferring a person between a first bed and a second bed while turning the person between a supine position and a prone position using a wrap and a lift, the method including the steps of wrapping the person in the wrap, attaching a lateral side of the wrap to the lift, lifting the supine/prone wrapped person above the first bed using the lift, moving the suspended person laterally to above the second bed using the lift, lowering the person onto the second bed using the lift into a prone/supine position, detaching the wrap from the lift, and unwrapping the person.

The method may include removing the wrap from under the person.

The wrap may be a two-part wrap, and the method may include leaving one part of the wrap under the person.

Another embodiment provides a method for checking the head of a prone person on a bed using a wrap and a lift, the method including the steps of placing the wrap under the patient, attaching both lateral sides of the wrap to the lift at the head-end of the wrap only, lifting the torso and head of the person above the bed using the lift, checking the head of the person, lowering the torso and head back onto the bed, and detaching the wrap from the lift.

The method may include removing the wrap from under the person.

The wrap may be one part of a two-part wrap.

Another embodiment provides a one-part wrap for wrapping a person and elevating the person using an overhead lift.

Another embodiment provides a hospital stretcher or bed with an integral telescopic lift that has a range beyond the footprint of the stretcher.

The stretcher may comprise two or more telescopic outriggers.

The stretcher may comprise four telescopic outriggers.

The outriggers may be motorized.

The outriggers may have legs or casters.

The stretcher may comprise an interlock mechanism to prevent the telescopic lift from being extended before the outriggers, and to prevent the outriggers from being retracted before the telescopic lift.

The interlock mechanism may be electronic, informed by position sensors and effected through electromechanical brakes, stops or motor control.

The stretcher may comprise two or more fixed overhead rails oriented parallel to a lateral dimension of the stretcher.

The stretcher may comprise two or more overhead rails oriented parallel to a lateral dimension of the stretcher and horizontally movable in a lateral direction relative to the stretcher.

Some of the movable rails may be coupled to the fixed rails to allow movement. The coupling may comprise trolleys or trucks attached to one rail running in a slot or cavity of an adjacent rail. The coupling may comprise an intermediate carriage containing a set of ball bearings.

Some of the movable rails may be coupled to other of the movable rails to allow movement. The coupling may comprise trolleys or trucks attached to one rail running in a slot or cavity of an adjacent rail. The coupling may comprise an intermediate carriage containing a set of ball bearings.

The stretcher may comprise a lift-bearing overhead rail oriented parallel to a longitudinal dimension of the stretcher and horizontally movable in a lateral direction relative to the stretcher, the lift movable longitudinally along the rail.

The telescopic lift may be movable within a two-dimensional area relative to the stretcher.

The telescopic lift may be extendible on either lateral side of the stretcher.

The lift may comprise a frame for holding the overhead rails.

The frame may comprise two, three or four posts attached a bed of the stretcher.

Each post may be attached at or near a corner of the bed.

At least one post may be detachable from the frame and/or from the bed.

The detachable post may be hinged to allow it to be folded down parallel to the bed.

The detachable post may be telescopic, allowing it to be collapsed upwards towards the frame or downwards towards the bed.

The two head-end posts may be supported by a cross bar, with sufficient space below the cross bar to accommodate tubes etc. connected to a patient on the stretcher.

The cross bar may in turn be supported by a centrally-positioned post, or a pair of posts, or several posts, each post inset a sufficient distance from the lateral edge of the stretcher to accommodate tubes etc. connected to a patient on the stretcher, without such tubes protruding beyond the lateral sides of the stretcher. Gates or other retention mechanisms may be provided to prevent such tubes from inadvertently sliding off the edge of the stretcher, especially during transport.

At least one post may be bowed outwards laterally to provide increased elbow room, and may be adapted to swivel about a vertical axis to allow the bowing to be aligned with the longitudinal axis during transport.

Both head-end posts may be bowed and be adapted to swivel.

The lift may comprise a scale for determining the mass of a load attached to the lift, and the stretcher may comprise control logic to prevent extension of the telescopic lift that would result in tipping of the stretcher, and/or to warn that tipping may occur.

The stretcher may comprise extension rails that may be positioned to extend the range of the fixed rails.

An extension rail may have one or more support posts.

An extension rail may have a support post at or near its distal end.

A support post may be telescopic or folding.

A pair of extension rails may be connected via a cross bar.

The cross bar may be fixed. It may be fixed at or near the distal ends of the extension rails.

The cross bar may be movable between the proximate and distal ends of the extension rails.

The stretcher-lift may be rigidly attachable to a bed or the like for stabilization.

Another embodiment provides a mobile lift comprising a telescopic overhead lift, movable both laterally and longitudinally, according to a previous embodiment.

The mobile lift may comprise an open base with casters.

The base may comprise outriggers for stabilization, and the outriggers may be fixed or telescopic.

The mobile lift may be rigidly attachable to a bed or the like for stabilization.

Another embodiment provides a method of performing in-situ proning using the stretcher-lift or

The method may utilize the wrap.

Another embodiment provides a method of performing a lateral transfer using the stretcher-lift or mobile lift.

The method may utilize the wrap.

Another embodiment provides a method of performing a lateral transfer with simultaneous proning using the stretcher-lift or mobile lift.

The method may utilize the wrap.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1A shows a top plan view of a person on top of a back part of a two-part wrap;

FIG. 1B shows a front elevation view corresponding to the view of FIG. 1A;

FIG. 1C shows a top plan view with a front part of the wrap on top of the person;

FIG. 1D shows a front elevation view corresponding to the view in FIG. 1C;

FIG. 1E shows a top plan view with the back and front part of the wrap attached to each other along the sides of the person, i.e. wrapping the person;

FIG. 1F shows a front elevation view corresponding to the view in FIG. 1E;

FIG. 2A shows a front elevation view of the wrapped person suspended from a lift;

FIG. 2B shows a side elevation view corresponding to the view of FIG. 2A;

FIG. 3A shows a front elevation view of the wrapped person in a supine position on a bed below a lift;

FIG. 3B shows a front elevation view of the person with a lift being positioned laterally;

FIG. 3C shows a front elevation view of the lift connected to a lateral side of the wrapped person;

FIG. 3D shows a front elevation view of the lift partially lifting the lateral side of the wrapped person;

FIG. 3E shows a front elevation view of the lift vertically lifting the lateral side of the wrapped person;

FIG. 3F shows a front elevation view of the lift lifting the wrapped person above the bed;

FIG. 3G shows a front elevation view of the lift moving the wrapped person to an opposite side of the bed;

FIG. 3H shows a front elevation view of the lift lowering the wrapped person into contact with the bed;

FIG. 3I shows a front elevation view of the lift lowering the wrapped person further towards the bed;

FIG. 3J shows a front elevation view of the lift having lowered the wrapped person into a prone position on the bed;

FIG. 3K shows a front elevation view of the lift disconnected from the wrapped person;

FIG. 3L shows a front elevation view of the person unwrapped in a prone position on the bed;

FIG. 4A shows a top plan view of the wrapped person in a prone position on the bed, corresponding to the view of FIG. 3K;

FIG. 4B shows a front elevation view corresponding to the view of FIG. 4A;

FIG. 4C shows a top plan view of the prone person with the front and back parts of the wrap detached from each other;

FIG. 4D shows a front elevation view corresponding to the view in FIG. 4C;

FIG. 4E shows a top plan view with the back and front part of the prone person on top of the front part of the wrap, with the back part of the wrap removed;

FIG. 4F shows a front elevation view corresponding to the view in FIG. 4E;

FIG. 5A shows a front elevation view of a person in a supine position on a first bed on top of the back part of the wrap;

FIG. 5B shows a front elevation view of the person with a lift connected to both lateral sides of the back part of the wrap;

FIG. 5C shows a front elevation view of the person suspended by the lift above the first bed and being transported laterally;

FIG. 5D shows a front elevation view of the person suspended by the lift above a second bed and being transported laterally;

FIG. 5E shows a front elevation view of the person being lowered onto the second bed;

FIG. 5F shows a front elevation view of the person in a supine position on the second bed, with the lift disconnected from the wrap;

FIG. 6A shows a front elevation view of a wrapped person in a supine position on a first bed;

FIG. 6B shows a front elevation view of the person with a lift connected to and partially lifting a lateral side of the wrapped person;

FIG. 6C shows a front elevation view of the person suspended by the lift above the first bed and being transported laterally;

FIG. 6D shows a front elevation view of the person suspended by the lift above a second bed and being transported laterally;

FIG. 6E shows a front elevation view of the person being lowered into a prone position on the second bed;

FIG. 6F shows a front elevation view of the person in a prone position on the second bed, with the lift disconnected from the wrap and the back part of the wrap removed;

FIG. 7A shows a top elevation view of two lateral edges of the back and front parts of the wrap, detached from each other, with a hook-and-loop fastening mechanism;

FIG. 7B shows a front elevation view corresponding to the view of FIG. 7A;

FIG. 7C shows a top elevation view of the two lateral edges of the back and front parts of the wrap, attached to each other using the hook-and-loop fastening mechanism;

FIG. 7D shows a front elevation view corresponding to the view of FIG. 7C;

FIG. 8A shows a top elevation view of two lateral edges of the back and front parts of the wrap, detached from each other, with a buckle-and-strap fastening mechanism;

FIG. 8B shows a front elevation view corresponding to the view of FIG. 8A;

FIG. 8C shows a top elevation view of the two lateral edges of the back and front parts of the wrap, attached to each other using the buckle-and-strap fastening mechanism;

FIG. 8D shows a front elevation view corresponding to the view of FIG. 8C;

FIG. 9A shows a top elevation view of two lateral edges of the back and front parts of the wrap, detached from each other, with a zipper fastening mechanism;

FIG. 9B shows a front elevation view corresponding to the view of FIG. 9A;

FIG. 9C shows a top elevation view of the two lateral edges of the back and front parts of the wrap, attached to each other using the zipper fastening mechanism;

FIG. 9D shows a front elevation view corresponding to the view of FIG. 9C;

FIG. 10A shows a top elevation view of two lateral edges of the back and front parts of the wrap, detached from each other, with a combined hook-and-loop and zipper fastening mechanism;

FIG. 10B shows a front elevation view corresponding to the view of FIG. 10A;

FIG. 10C shows a top elevation view of the two lateral edges of the back and front parts of the wrap, attached to each other using the combined hook-and-loop and zipper fastening mechanism;

FIG. 10D shows a front elevation view corresponding to the view of FIG. 10C;

FIG. 11A shows a top elevation view of two lateral edges of the back and front parts of the wrap, detached from each other, with a dual zipper fastening mechanism;

FIG. 11B shows a top elevation view of two lateral edges of the back and front parts of the wrap, detached from each other, with a zipper fastening mechanism and an elastic panel;

FIG. 12A shows a top elevation view of two lateral edges of the back and front parts of the wrap, detached from each other, with connection points and handles, and a generic fastening mechanism;

FIG. 12B shows a top elevation view of the two lateral edges of the back and front parts of the wrap, attached to each other using the generic fastening mechanism;

FIG. 12C shows a front elevation view of a wrapped person, showing the handles;

FIG. 12D shows a front elevation view of the wrapped person suspended by a lift, with the lift connected to the connection points;

FIG. 12E shows a top plan view of two lateral edges of the back and front parts of the wrap, detached from each other, with connection points and handles, and a segmented hook-and-loop fastening mechanism;

FIG. 12F shows a top elevation view of the two lateral edges of the back and front parts of the wrap, attached to each other using the segmented hook-and-loop mechanism;

FIG. 13A shows a top plan view of a person in a supine position on top of an air-supplied back part of a wrap;

FIG. 13B shows a top plan view of a person in a prone position on top of an air-supplied front part of a wrap;

FIG. 14A shows a front elevation view of a person wrapped in an oversized wrap, with interstitial spaces;

FIG. 14B shows a front elevation view of the person wrapped in the oversized wrap, with the interstitial spaces containing air bladders in an uninflated state;

FIG. 14C shows a front elevation view of the person wrapped in the oversized wrap, with the interstitial air bladders in an inflated state;

FIG. 14D shows a top plan view corresponding to the view of FIG. 14C, with an air supply for the air bladders;

FIG. 15A shows a side elevation view of a wrapped person suspended by a lift, with an air bladder providing rigidity inside the wrap;

FIG. 15B shows a side elevation view of a wrapped person suspended by a lift, with a rigid part providing rigidity inside the wrap;

FIG. 16A shows a front elevation view of a person in a prone position on top of a front part of a wrap;

FIG. 16B shows a front elevation view of the person with a lift connected to both lateral sides of the front part of the wrap;

FIG. 16C shows a front elevation view of the person with their head and torso partially suspended by the lift;

FIG. 16D shows a side elevation view of the person with their head and torso partially suspended by the lift;

FIG. 17A shows a front elevation view of a one-piece wrap wrapping a person;

FIG. 17B shows a front elevation view of the person suspended by a lift wrapped in the one-piece wrap;

FIG. 17C shows a front elevation view of the person in a prone position on top of the one-piece wrap;

FIG. 17D shows a top elevation view corresponding to the view of FIG. 17C;

FIG. 18A shows a top plan view of a person on top of a back part of a longer two-part wrap;

FIG. 18B shows a front elevation view corresponding to the view of FIG. 18A;

FIG. 18C shows a top plan view with a front part of the wrap on top of the person;

FIG. 18D shows a front elevation view corresponding to the view in FIG. 18C;

FIG. 18E shows a top plan view with the back and front part of the wrap attached to each other along the sides of the person, i.e. wrapping the person;

FIG. 18F shows a front elevation view corresponding to the view in FIG. 18E;

FIG. 19A shows a side elevation view of a hospital stretcher with an integral lift;

FIG. 19B shows an end elevation view of the stretcher of FIG. 19A;

FIG. 19C shows a plan view of the stretcher of FIG. 19A;

FIG. 20A shows an end elevation view of the stretcher of FIG. 19A with its telescopic lift rails fully extended above an adjacent operating table;

FIG. 20B shows a plan view of the stretcher and operating table of FIG. 20A;

FIG. 20C shows a plan view of the stretcher and operating table of FIG. 20A, highlighting the area covered by the lift;

FIG. 21A shows a side elevation view of a cross section of the telescopic rails of the stretcher of FIG. 19A;

FIG. 21B shows a plan view of a cross section of the telescopic rails of the stretcher of FIG. 19A;

FIG. 22A shows an end elevation view of a cross section of the cross rail of the stretcher of FIG. 19A;

FIG. 22B shows a side elevation view of a cross section of the cross rail of the stretcher of FIG. 19A;

FIG. 22C shows a side elevation view of a cross section of the cross rail of the stretcher of FIG. 19A with an internal lift;

FIG. 23A shows a simplified isometric view of the lift support frame of the stretcher of FIG. 19A, with an additional cross bar;

FIG. 23B shows a simplified isometric view of the lift support frame of the stretcher of FIG. 19A, with a third support post;

FIG. 23C shows a simplified isometric view of the lift support frame of the stretcher of FIG. 19A, with a fourth support post;

FIG. 23D shows a simplified isometric view of the lift support frame of the stretcher of FIG. 19A, with added struts;

FIG. 23E shows a simplified isometric view of the lift support frame of the stretcher of FIG. 19A, with added side braces and struts;

FIG. 23F shows a simplified isometric view of the lift support frame of the stretcher of FIG. 19A, with a centrally-positioned head-end support post;

FIG. 24A shows a side elevation view of an hospital stretcher with an integral lift extendable on both sides of the stretcher;

FIG. 24B shows an end elevation view of the stretcher of FIG. 24A;

FIG. 24C shows a plan view of the stretcher of FIG. 24A;

FIG. 25A shows an end elevation view of the stretcher of FIG. 24A with its telescopic lift rails fully extended above an adjacent operating table;

FIG. 25B shows a plan view of the stretcher and operating table of FIG. 25A;

FIG. 26A shows a plan view of the outrigger mechanisms of the stretcher of FIG. 24A;

FIG. 26B shows a plan view of the outrigger mechanisms with two outriggers extended adjacent to an operating table;

FIG. 27A shows an end elevation view of FIG. 25A, annotated with variables used to calculate the lateral stability of the stretcher;

FIG. 27B shows an equation defining the stability condition;

FIG. 28A shows a side elevation view of a cross section of the telescopic rails of the stretcher of FIG. 24A;

FIG. 28B shows a plan view of a cross section of the telescopic rails of the stretcher of FIG. 24A;

FIG. 29A shows a perspective view of the stretcher of FIG. 24A with the telescopic rails retracted;

FIG. 29B shows a perspective view of the stretcher of FIG. 24A with the telescopic rails extended;

FIG. 30A shows a perspective view of the stretcher of FIG. 24A, further modified with the removal of the outer rails;

FIG. 30B shows a perspective view of the stretcher of FIG. 30A with the telescopic rails extended;

FIG. 31A shows a perspective view of the stretcher of FIG. 30A, further modified with extendable fixed rails with telescopic support posts;

FIG. 31B shows a perspective view of the stretcher of FIG. 31A with the extendable fixed rails extended and support posts lowered;

FIG. 31C shows a perspective view of the stretcher of FIG. 31A with the extendable fixed rails extended, support posts lowered, and lift fully extended;

FIG. 31D shows a perspective view of the stretcher of FIG. 31A with the extendable fixed rails extended, support posts lowered, lift fully extended, and operating table present;

FIG. 32A shows a perspective view of the stretcher of FIG. 31A, further simplified with no movable side rails;

FIG. 32B shows a perspective view of the stretcher of FIG. 32A with the extendable fixed rails extended and support posts lowered;

FIG. 32C shows a perspective view of the stretcher of FIG. 32A with the extendable fixed rails extended, support posts lowered, and lift fully extended;

FIG. 32D shows a perspective view of the stretcher of FIG. 32A with the extendable fixed rails extended, support posts lowered, lift fully extended, and operating table present;

FIG. 33A shows a perspective view of the stretcher of FIG. 24A using ball bearing-based telescopic rails in place of trolley-based telescopic rails;

FIG. 33B shows a side elevation view of a cross section of the telescopic rails of the stretcher of FIG. 33A;

FIG. 34A shows an end elevation view of a bearing-based telescopic rail;

FIG. 34B shows a side elevation view of the bearing-based telescopic rail of FIG. 34A;

FIG. 34C shows an end elevation view of the bearing-based telescopic rail of FIG. 34A, with a corresponding inner rail member present;

FIG. 34D shows a side elevation view of the bearing-based telescopic rail of FIG. 34C;

FIG. 34E shows an end elevation view of the bearing-based telescopic rail of FIG. 34A, with end stops present and ball bearing carriage absent;

FIG. 34F shows a side elevation view of the bearing-based telescopic rail of FIG. 34E, with the ball bearing carriage at an extreme position, and the inner rail absent;

FIG. 34G shows a side elevation view of the bearing-based telescopic rail of FIG. 34E, with the ball bearing carriage at an extreme position, and the inner rail present in outline;

FIG. 35A shows a simplified isometric view of the lift support frame of the stretcher of FIG. 33A, with the head-end support post supported by a cross bar and centrally-positioned post;

FIG. 35B shows an end elevation of the support frame of FIG. 35A;

FIG. 35C shows a simplified isometric view of the lift support frame of the stretcher of FIG. 33A, with the head-end support post supported by a cross bar and two centrally-positioned spaced-apart posts;

FIG. 35D shows an end elevation of the support frame of FIG. 35C;

FIG. 35E shows a simplified isometric view of the lift support frame of the stretcher of FIG. 33A, with the head-end support post supported by a pair of cross bars and two centrally-positioned spaced-apart posts;

FIG. 35F shows an end elevation of the support frame of FIG. 35E;

FIG. 35G shows an end elevation of the support frame of FIG. 35C, with retention gates;

FIG. 35H shows an end elevation of the support frame of FIG. 35G, with one retention gate open;

FIG. 36A shows a side elevation view of the stretcher of FIG. 33A, with curved head-end posts adapted to swivel, and supported according to FIG. 35C;

FIG. 36B shows a head end elevation view of the stretcher of FIG. 36A, with the curved head-end posts positioned parallel to the stretcher;

FIG. 36C shows a partial head end elevation view of the stretcher of FIG. 36A, with the curved head-end posts positioned perpendicular to the stretcher;

FIG. 37A shows a side elevation view of an mobile lift;

FIG. 37B shows an end elevation view of the lift of FIG. 37A;

FIG. 37C shows a plan view of the lift of FIG. 37A;

FIG. 38A shows an end elevation view of the lift of FIG. 37A with its telescopic lift rails fully extended;

FIG. 38B shows a plan view of the lift of FIG. 38A; and

FIG. 39 shows a plan view of the base of the lift of FIG. 37A with its outriggers extended below an adjacent bed.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Embodiments of the present invention may be used to reposition a person. The person may be any person, including, without limitation, a hospital patient, a bed-ridden nursing home resident, a person who has suffered a fall, or in general any person in need of handling, e.g. by care staff, due to a chronic or acute condition. The term “patient”, unless specified otherwise, shall encompass, as used herein, any person requiring such handling. Likewise, the term “bed”, unless specified otherwise, shall encompass, as used herein, any surface on which such a person is resting.

Exemplary wraps for elevating, reorienting and repositioning a person with the assistance of a lift are disclosed in Beed et al., U.S. Pat. No. 11,357,685, “Apparatus and method for reorienting a person”, the contents of which are incorporated herein by reference. Embodiments of the present invention include additional wrap variations for elevating, reorienting and repositioning a person with the assistance of a lift, and related methods pertaining to both prior and present wraps.

Embodiments include two-part wraps 1200 similar to wraps described in U.S. Pat. No. 11,357,685 (Beed), but adapted to be closed using closures on the two lateral sides rather than at the front and back.

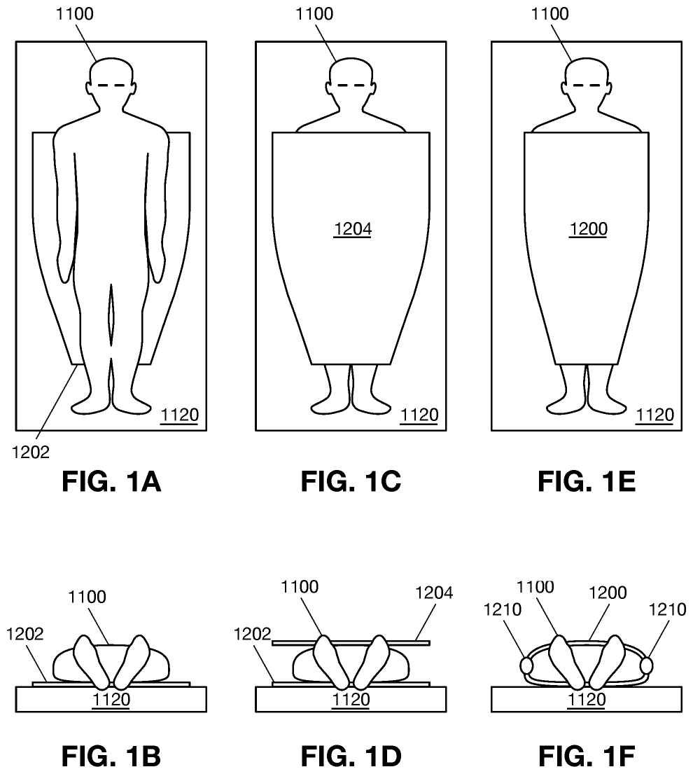

FIG. 1A shows a top plan view of a person 1100, in a supine position on a bed 1120, on top of a back part 1202 of a two-piece wrap 1200. FIG. 1B shows a corresponding front elevation view.

FIG. 1C shows a top plan view with a front part 1204 of the wrap 1200 on top of the person 1100. FIG. 1D shows a corresponding front elevation view.

FIG. 1E shows a top plan view with the back part 1202 and front part 1204 attached to each other along the sides of the person 100, i.e. forming the complete wrap 1200, and wrapping the person 1100 snugly in the complete wrap. FIG. 1F shows a corresponding front elevation view corresponding. An adjustable closure assembly 1210 on each lateral side of the complete wrap 1200 each provides a mechanism for fastening each lateral edge of the back part 1202 to a corresponding lateral edge of the front part 1204 in an adjustable manner, allowing a secure and snug fit of the wrap 1200 to the person 1100.

Once snugly cocooned in the wrap 1200, the person 1100 may be attached to a ceiling or portable lift 1300 and securely elevated above the bed 1120 for the purposes of repositioning or reorienting the person 1100.

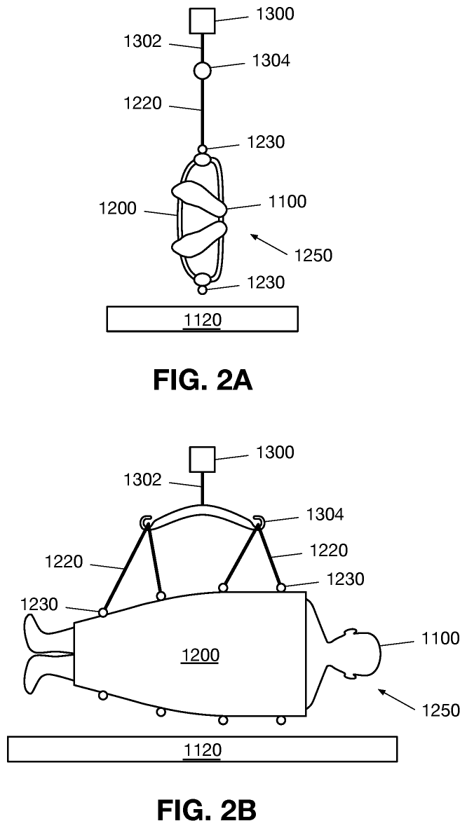

FIG. 2A shows a front elevation view of the wrapped person 1250, i.e. person 1100 securely cocooned in wrap 1200, suspended from a lift 1300 above the bed 1120. Elevating the person 1100 in this way allows the person 1100 to be safely repositioning or reoriented. FIG. 2B shows a corresponding side elevation view.

The lift 1300 may be any suitable ceiling or portable lift, as described in Beed, and incorporates a motorized cable 1302 attached to a t-bar 1304 or similar.

The wrap 1200 incorporates a set of connection points 1230 along its two lateral sides, for connecting the wrap 1200 to the t-bar 1304 via straps 1220. As described in Beed, while FIG. 2B shows four connection points 1230 along each lateral side of the wrap 1200, and four attachment straps 1220, the number of connection points 1230 and straps 1220 may be different, and need not be the same as each other. The number of connection points 1230 may be different, e.g. to support the connection of a larger or smaller number of straps 1220, or to provide options for load levelling. The number of straps 1220 may be different, e.g. if the wrap incorporates stiffening and thus requires fewer straps. Each strap 1220 may have an adjustable length, e.g. via a buckle.

As described in U.S. Pat. No. 11,357,685 (Beed), an intermediate support structure (e.g. bar) may be (but need not be) utilised between the t-bar 1304 and the attachment straps 1220, e.g. to provide a wider support structure for the attachment straps 1220, or to provide a more dispersed set of connection points on the support structure than provided by the hooked ends of the t-bar 1304.

The wrap 1200 may be used in conjunction with a lift 1300 to reorient a person 1100 between a supine position and a prone position. For example, the treatment of lung diseases such as Acute Respiratory Distress Syndrome (ARDS) may call for periodic turning of a person 1100 between a supine and prone position. Surgery requiring access to the back of a person 1100, such as spinal surgery and hemorrhoid surgery, typically requires the turning of the person 1100 from a normal supine position prior to surgery, to a prone position during surgery, and then back to a supine position after surgery, often while the person 1100 is partially or fully sedated and thus unable to assist. A bed-ridden person 1100 may benefit from being turned from a supine position to a prone position for cleaning and other personal care, and to relieve pressure.

Turning a person 1100 is labour-intensive and involves a risk of injury to care staff. This is particularly so in the case of a bariatric person 1100.

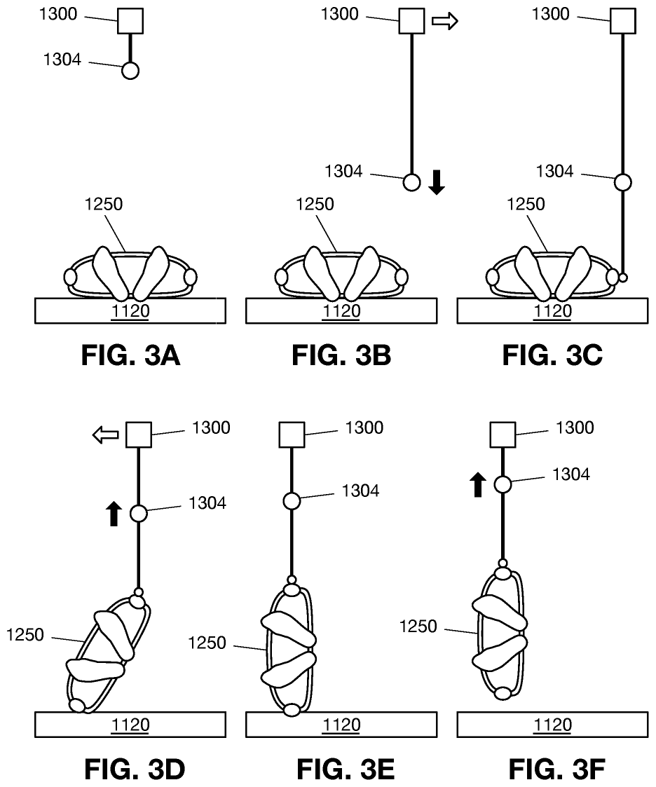

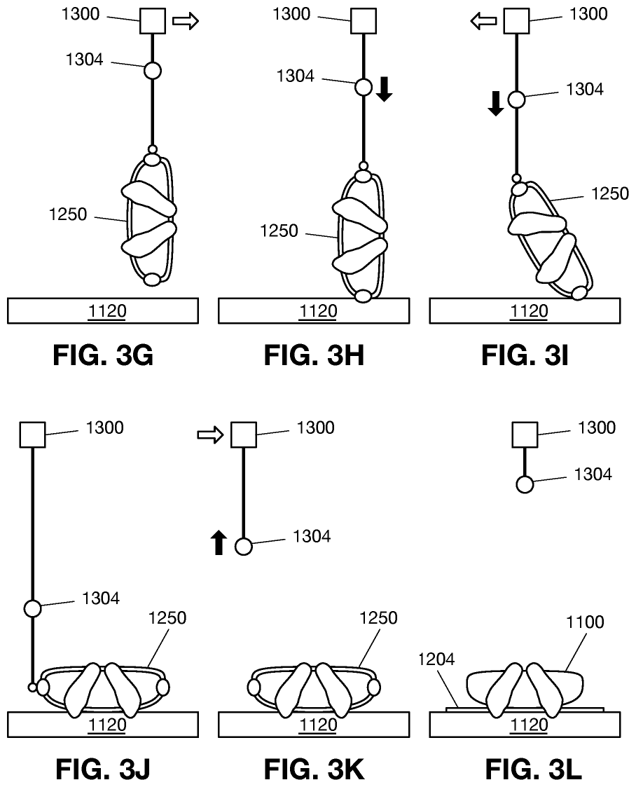

FIGS. 3A through 3L show the steps of a process for proning a person 1100 using the wrap 1200 and a lift 1300. Returning the person 1100 to a supine position is accomplished by reversing the steps of the process.

FIG. 3A shows a front elevation view of the wrapped person 1250 in a supine position on a bed 1120 below a lift 1300. The person 1100 is already shown wrapped by wrap 1200, accomplished by the steps shown in FIGS. 1A through 1F.

FIG. 3B shows the lift 1300 being moved laterally to position it above one lateral side of the wrapped person 1250, and the t-bar 1304 being lowered towards the wrapped person 1250. The open arrow indicates lateral movement of the lift 1300. The solid arrow indicates vertical movement of the t-bar 1304 under control of the lift 1300.

FIG. 3C shows the lift 1300 connected to a lateral side of the wrapped person 1250. FIG. 3D shows the lift 1300 partially lifting the lateral side of the wrapped person 1250. FIG. 3E shows the lift 1300 having lifting the lateral side of the wrapped person 1250 so the lateral axis of the wrapped person 1250 is vertical, and the wrapped person 1250 is barely touching the bed 1120. FIG. 3F shows the lift 1300 lifting the wrapped person 1250 above the bed 1120. FIG. 3G shows the lift 1300 moving the wrapped person 1250 laterally to an opposite side of the bed 1120. FIG. 3H shows the lift 1300 lowering the wrapped person 1250 into contact with the bed 1120. FIG. 3I shows the lift 1300 lowering the wrapped person 1250 further towards the bed 1120. Lateral movement of the lift 1300 towards the center of the bed 1120 ensures that the wrapped person 1250 is lowered to a prone position. Alternatively or additionally, this can be achieved by care staff gently pushing the top lateral part of the wrapped person 1250 towards the center of the bed 1120. FIG. 3J shows the lift 1300 having lowered the wrapped person 1250 into a prone position on the bed 1220. FIG. 3K shows the lift 1300 disconnected from the wrapped person 1250. And finally, FIG. 3L shows the person 1100 unwrapped in a prone position on the bed 1120, lying on top of the front part 1204 of the wrap 1200.

The lift 1300 may incorporate a lateral drive motor, in which case lateral movement may be driven by the lift itself. Typically, however, the lift 1300 does not incorporate a lateral drive motor, and any movement of the lift is effected by care staff pushing or pulling the load suspended under the lift, such as the wrapped person 1250.

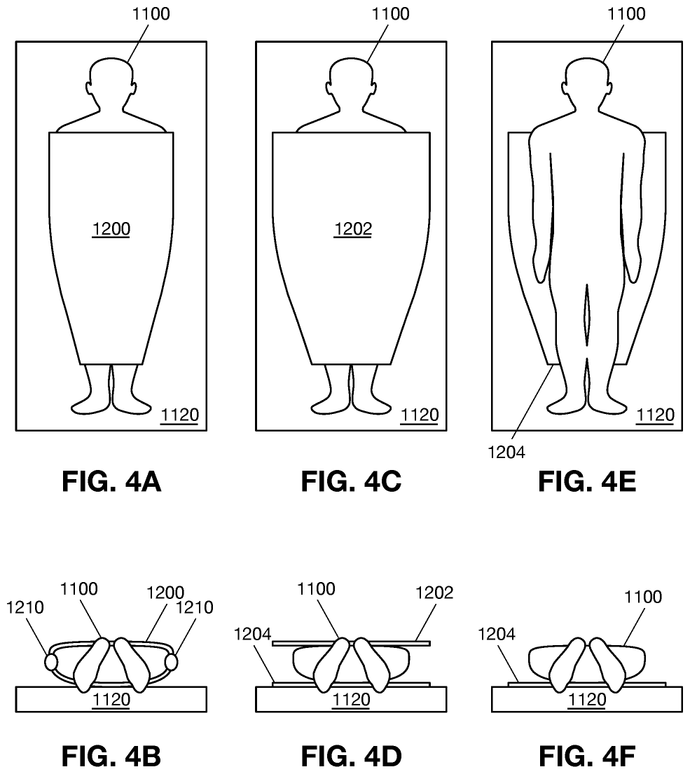

FIGS. 4A through 4F show the unwrapping of the person 1100 from the wrap 1200 in the prone position on the bed 1120, including the opening of the side closures 1210, and the removal of the back part 1202 of the wrap 1200.

Laterally transferring a person 1100, e.g. between two beds, to/from a stretcher, or to/from an operating table, is also labour-intensive and involves a risk of injury to care staff. This is particularly so in the case of a bariatric person 1100.

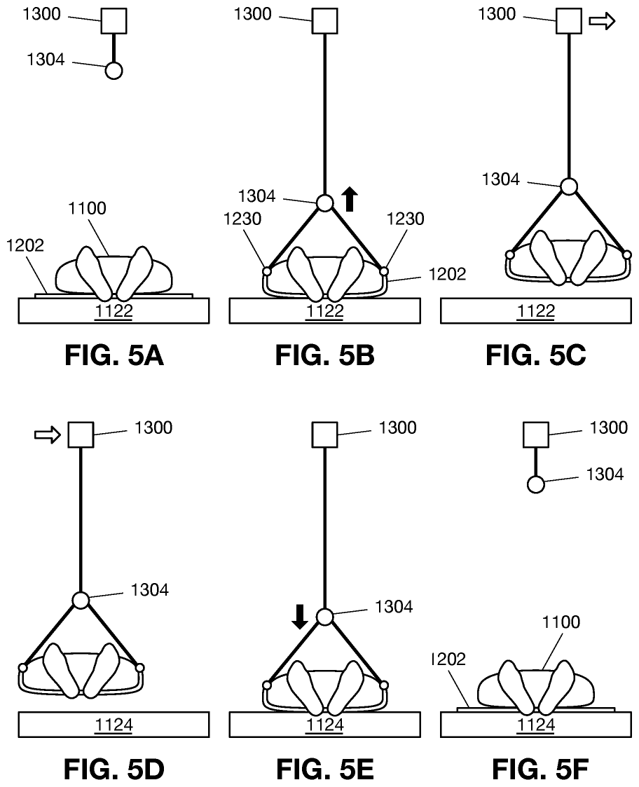

FIGS. 5A through 5F show the steps of a process for laterally transferring a person 1100 using the wrap 1200 and a lift 1300. Although shown between two beds 1122 and 1124, the process applies to any lateral transfer so long as a lift 1300 is available.

FIG. 5A shows a front elevation view of a person 1100 in a supine position on a first bed 1122 on top of the back part 1202 of the wrap 1200. FIG. 5B shows the person 1100 with a lift 1300 connected to connection points 1230 on both lateral sides of the back part 1202 of the wrap 1200, and starting to lift the person 1100 above the first bed 1122. FIG. 5C shows the person 1100 suspended by the lift 100 above the first bed 1122 and being transported laterally towards a second bed 1124 to the right (not shown). FIG. 5D shows the person 1100 suspended by the lift 1300 above the second bed 1124 and being transported laterally. FIG. 5E shows the person 1100 being lowered onto the second bed 1124. FIG. 5F shows the person 1100 in a supine position on the second bed 1124, with the lift 1300 disconnected from the back part 1202 of the wrap 1200.

The same process applies to laterally transferring a prone person 1100 using the front part 1204 of the wrap 1200.

In some cases it is advantageous to turn a person 1100 at the same time as laterally transferring them, e.g. when transferring them onto an operating table prior to prone surgery, or transferring them from an operating table after prone surgery.

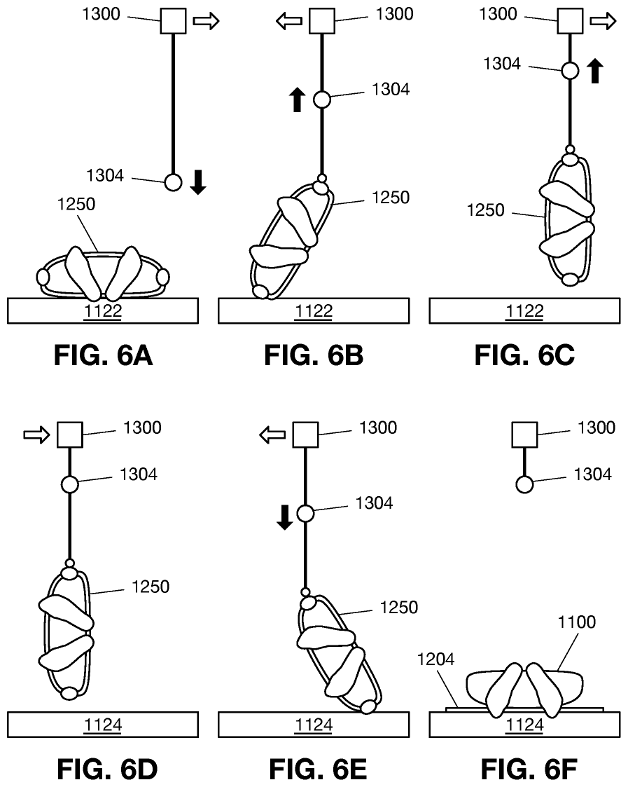

FIGS. 6A through 6F show the steps of a process for laterally transferring and simultaneously turning a person 1100 using the wrap 1200 and a lift 1300. Although shown between two beds 1122 and 1124, the process applies to any lateral transfer so long as a lift 1300 is available.

FIG. 6A shows a front elevation view of a wrapped person 1250 in a supine position on a first bed 1122, with a lift 1300 being moved into position. FIG. 6B shows the person with a lift 1300 connected to and partially lifting a lateral side of the wrapped person 1250. FIG. 6C shows the person 1100 suspended by the lift 1300 above the first bed 1122 and being transported laterally towards a second bed to the right 1124 (not shown). FIG. 6D shows the person 1100 suspended by the lift 1300 above the second bed 1124 and being transported laterally. FIG. 6E shows the person 1100 being lowered into a prone position on the second bed 1124. FIG. 6F shows the person 1100 in a prone position on the second bed 1124, with the lift 1300 disconnected from the wrap 1200 and the back part 1202 of the wrap 1200 removed.

There are several advantages to utilising a wrap 1200 with side closures rather than front and back closures. To gain maximum benefit from the wrap 1200, the back wrap part 1202 is always left under a bed-ridden person 1100 when in a supine position, and the front wrap part 1204 is always left under the bed-ridden person when in a prone position. This way the full wrap 1200 can be deployed quickly by simply attaching the complementary wrap part, without having to manhandle the person 1100 to position a device under them. By having a seamless wrap part under the patient, the risk of the wrap 1200 inducing a pressure injury is minimised. By separating the two wrap parts, a soiled wrap part under a person 1100 can be removed, cleaned and/or replaced by turning the person 1100 using the wrap 1200 and lift 1300. The person 1100 can likewise be cleaned. By having only one part of the wrap 1200 under the person 1100 at a time, there is less excess material to manage when the wrap is not being used for lifting. Also, the two wrap parts can be identical and sized so that the person 1100 is fully cocooned when wrapped.

The wrap 1200 may advantageously be for single-patient use, to guarantee optimal performance and hygiene. The wrap 1200 may optionally be for multi-patient use, allowing laundering between patient uses.

The wrap 1200 is composed of any suitably flexible and strong fabric or mesh, utilising e.g. a polyester, cotton or lyocell material.

A variety of fastening mechanisms may be employed in the closure assembly 1210. A number of mechanisms are described below with reference to the Figures, and persons skilled in the art will appreciate that there are yet more alternative implementations. Each closure assembly 1210 allows the back part 1202 and front part 1204 to be attached to each other to form the complete wrap 1200, and optionally provides adjustability to ensure a snug fit of the wrap 1200 to the person 1100. The two closure assemblies 1210 are advantageously identical, but need not be, and advantageously both provide adjustability, but need not do so. Compatibility for different sizes and morphologies of the person 1100 may also be provided via different sized and shaped wraps 1200.

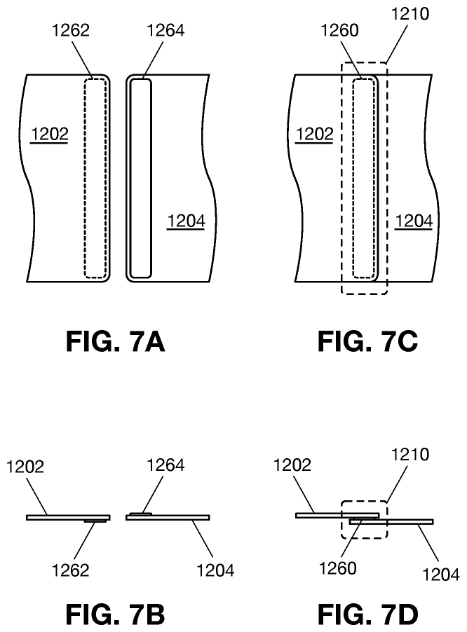

FIG. 7A shows a top elevation view of one lateral edge of the back part 1202 and one lateral edge of the front part 1204 of the wrap 1200, detached from each other, with a hook-and-loop fastening mechanism 1260. Only a single closure mechanism, for a single pair of edges, is shown. The closure mechanism for the other pair of edges is omitted for clarity. The back part 1202 incorporates a first part 1262 of the hook-and-loop fastener 1260, facing downwards in the Figure, and the front part 1204 incorporates a second part 1264 of the hook-and-loop fastener 1260, facing upwards in the Figure. FIG. 7B shows a corresponding front elevation view. FIG. 7C shows the lateral edge of the back part 1202 and the lateral edge of the front part 1204 attached to each other using the hook-and-loop fastener 1260, with the first part 1262 and second part 1264 now attached face-to-face. FIG. 7D shows a corresponding front elevation view. Varying the lateral alignment of the first part 1262 and second part 1264 provides adjustability.

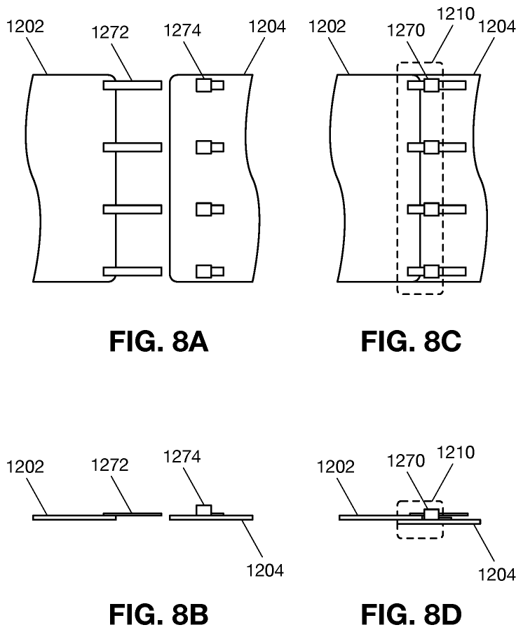

FIG. 8A shows a top elevation view of one lateral edge of the back part 1202 and one lateral edge of the front part 1204 of the wrap 1200, detached from each other, with a buckle-and-strap fastening mechanism 1270. The back part 1202 incorporates a strap 1272 of the fastener 1270, and the front part 1204 incorporates a buckle 1274 of the fastener 1270. FIG. 8B shows a corresponding front elevation view. FIG. 8C shows the lateral edge of the back part 1202 and the lateral edge of the front part 1204 attached to each other using the buckle-and-strap fastener 1270. FIG. 8D shows a corresponding front elevation view. Varying the point at which the buckle 1274 cinches the strap 1272 provides adjustability.

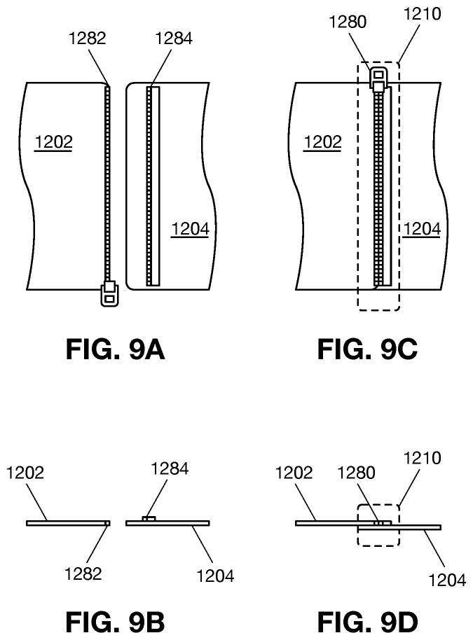

FIG. 9A shows a top elevation view of one lateral edge of the back part 1202 and one lateral edge of the front part 1204 of the wrap 1200, detached from each other, with a zipper fastening mechanism 1280. The back part 1202 incorporates a first part 1282 of the fastener 1280, and the front part 1204 incorporates a second part 1284 of the fastener 1280. FIG. 9B shows a corresponding front elevation view. FIG. 9C shows the lateral edge of the back part 1202 and the lateral edge of the front part 1204 attached to each other using the zipper fastener 1280. FIG. 9D shows a corresponding front elevation view. Options for providing adjustability are discussed in relation to the following Figures.

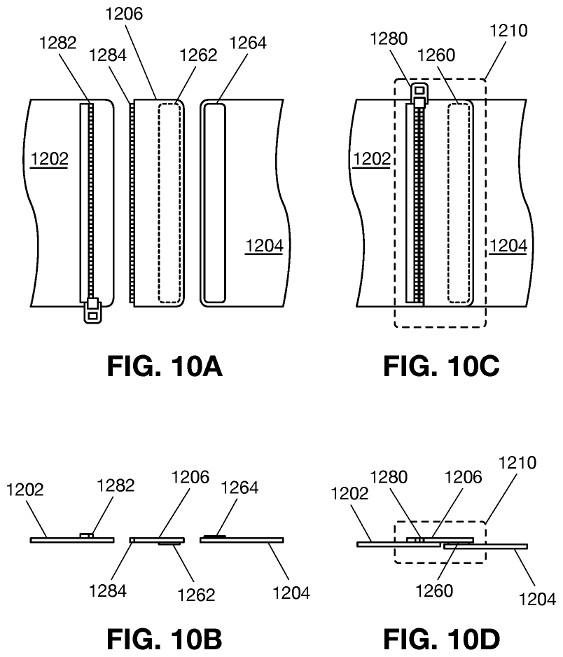

FIG. 10A shows a top elevation view of one lateral edge of the back part 1202 and one lateral edge of the front part 1204 of the wrap 1200, detached from each other, with a combined hook-and-loop 1260 and zipper 1280 fastening mechanism. The back part 1202 incorporates the first part 1282 of the zipper fastener 1280. A new joining part 1206 incorporates the second part 1284 of the zipper fastener 1280 along its first edge, and the first part 1262 of the hook-and-loop fastener 1260 along its second edge. The front part 1204 provides the second part 1264 of the hook-and-loop fastener 1260. FIG. 10B shows a corresponding front elevation view. FIG. 10C shows the lateral edge of the back part 1202 and the first lateral edge of the joining part 1206 attached to each other using the zipper fastener 1280, and the second lateral edge of the joining part 1206 and the lateral edge of the second part 1204 attached to each other using the hook-and-loop fastener 1260. FIG. 10D shows a corresponding front elevation view.

In typical use, the hook-and-loop fastener within one or both closure assemblies 1210 may be used to ensure a snug fit of the wrap 1200 to a patient 1100. During subsequent opening and closing of the closures 1210, the zipper fasteners 1280 may be more conveniently used.

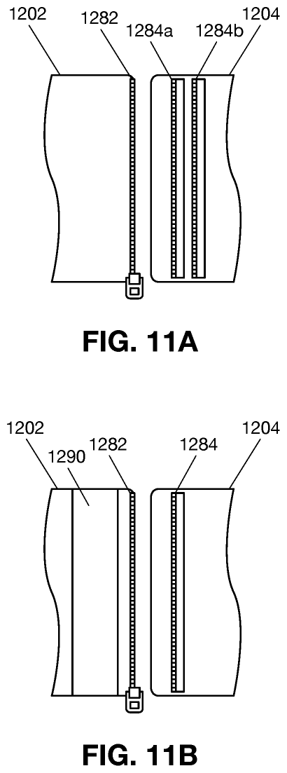

FIG. 11A shows the zipper-based closure assembly of FIG. 9A, but with the second wrap part 1204 incorporating two second parts 1284a and 1284b of the zipper fastener 1280, spaced apart laterally. Varying the choice of zipper part 1284a or 1284b provides adjustability. More than two second zipper parts 1284 may also be provided for increased adjustability.

FIG. 11B shows the zipper-based closure assembly of FIG. 9A, but with the first wrap part 1202 incorporating an elastic panel 1290. The elastic range of the elastic panel 1290 provides adjustability.

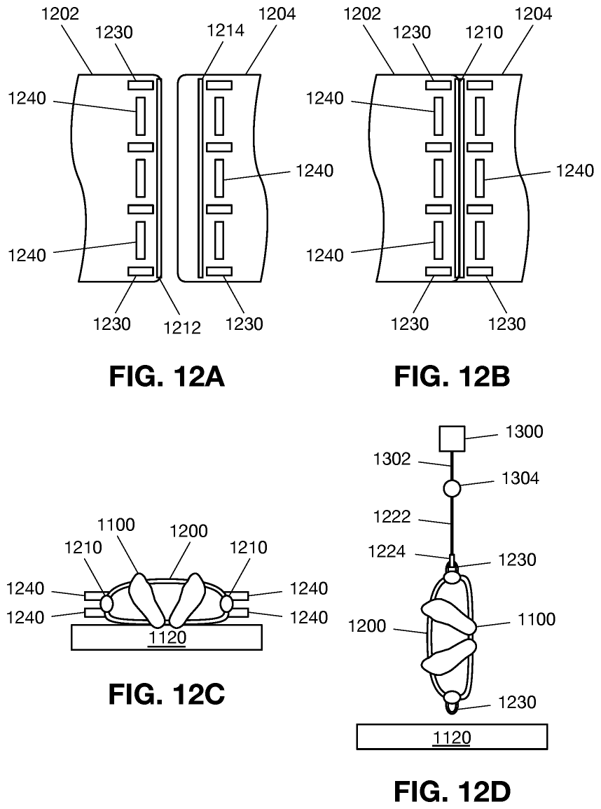

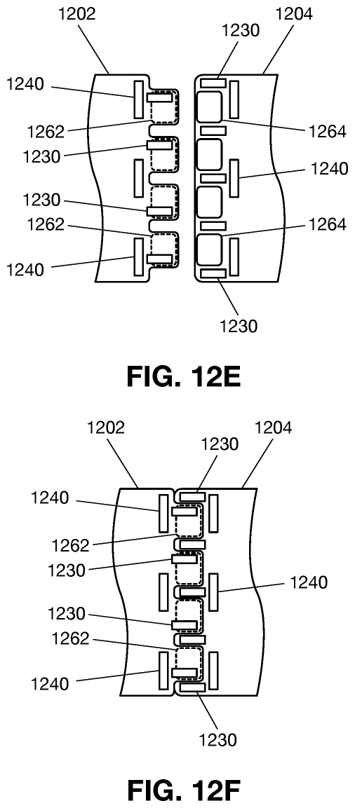

FIG. 12A shows a top elevation view of one lateral edge of the back part 1202 and one lateral edge of the front part 1204 of the wrap 1200, detached from each other, with a generic closure assembly 1210. The back part 1202 incorporates a first part 1212 of the closure assembly 1210, and the front part 1204 incorporates a second part 1214 of the closure assembly 1210. The back wrap part 1202 and front wrap part 1204 incorporates a set of connection points 1230 and handles 1240. FIG. 12B shows the lateral edge of the back wrap part 1202 and the lateral edge of the front wrap part 1204 attached to each other using the closure assembly 1210. The closure assembly 1210 may utilise any mechanism discussed above.

As shown in FIG. 12C, each handle 1240 facilitates manual manipulation of the person 1100 in the wrap 1200, whether on a bed 1120 or suspended by a lift 1300. As shown in FIG. 12D, each connection point 1230 allows a strap 1222 to be connected to the wrap 1200 via a carabiner 1224 or similar.

FIG. 12E shows the hook-and-loop-based closure assembly of FIG. 7A, combined with the connection points 1230 and handles 1240 of FIG. 12A. The lateral edge of the back wrap part 1202 is divided into a set of tabs, each incorporating a small first part 1262 of the hook-and-loop fastener 1260. Similarly, the front wrap part 1204 incorporates a matching set of small second parts 1264 of the hook-and-loop fastener 1260. The tabs facilitate easier tab-wise opening and closing of the hook-and-loop fastener 1260 along the full length of the wrap 1200. The tabs also allow the connection points 1230 on the back wrap part 1202 and front wrap part 1204 to roughly align when the wrap 1200 is closed, as shown in FIG. 12F, allowing each attachment strap carabiner 1224 to be secured through a pair of connection points 1230, providing additional protection against the wrap 1200 opening under load.

A number of air-assisted mechanisms exist to facilitate patient handling, prevent injury, and increase patient comfort.

An air transfer mat creates a low-friction air cushion by expelling air through a set of apertures, facilitating easier patient movement. See for example U.S. Pat. Nos. 6,898,809, 6,073,291, 7,712,170, and 7,373,680, the contents of all of which are incorporated herein by reference thereto.

An alternating pressure mattress incorporates a set of cells which are inflated and deflated in alternating fashion to reduce the likelihood of pressure injuries to a patient. See for example U.S. Pat. Nos. 10,034,808, 8,087,113, 7,913,338, 7,877,829, 7,784,132, 7,444,704, and 7,299,823, the contents of all of which are incorporated herein by reference thereto.

A microclimate management mattress incorporates airflow to carry moisture away from the skin of a patient. See for example U.S. Pat. Nos. 10,716,724, 10,568,435, 10,390,717, 10,172,470, 9,907,408, 9,835,344, 9,538,853, 9,326,903, 9,254,231, 8,918,930, 8,372,182, 8,118,920, and 7,914,611, the contents of all of which are incorporated herein by reference thereto.

Each of these air-assisted mechanisms, either alone or in combination, may be advantageously incorporated in the wrap 1200.

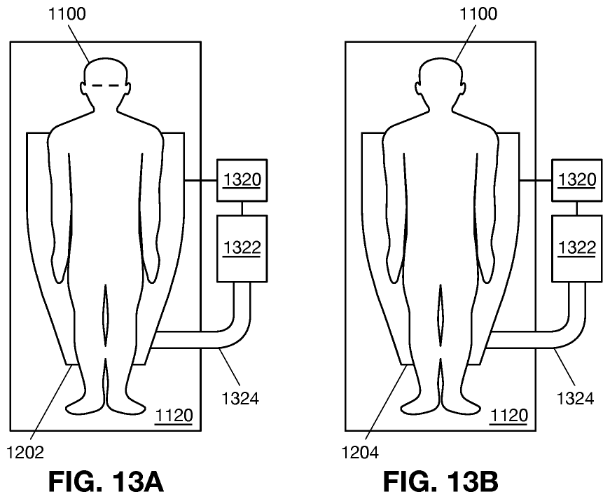

FIG. 13A shows a top plan view of a person 1100 in a supine position on top of an air-supplied back part 1202 of a wrap 1200, and FIG. 13B shows the person 1100 in a prone position on top of an air-supplied front part 1204 of the wrap 1200. An air pump 1322 provides a supply of air to the wrap 1200 via an air hose 1324. An optional controller 1320 monitors the status of the air-supplied wrap 1200, and adjusts the air supply by controlling the pump 1322 or by controlling the activation of chambers or cells within the wrap 1200, such as when alternating pressure. The air hose 1324 may be manually detached from the back wrap part 1202 and attached to the front wrap part 1204 when the person 1100 is turned from a supine to a prone position, and vice versa when the person 1100 is turned from a prone to a supine position.

In addition to incorporating air-assisted mechanisms in the wrap 1200, air-assisted devices may be advantageously deployed in conjunction with a wrap 1200. For example, prior to a person 1100 being turned from supine to prone using a wrap 1200 (or similar, e.g. Beed), an air-assisted device may be placed inside the front of the wrap 1200. Once the person 1100 is in a prone position and the wrap 1200 is opened, the air-assisted device will be between the person 1100 and the bed 1120 and can be connected to an air supply to perform its desired function. Similarly, the air-assisted device can be attached to the outside of the front of the wrap 1200 prior to proning, so that it ends up between the bed 1120 and the front of the wrap 1200 once the person is proned. The same processes can be employed when turning a person 1100 from prone to supine using a wrap 1200.

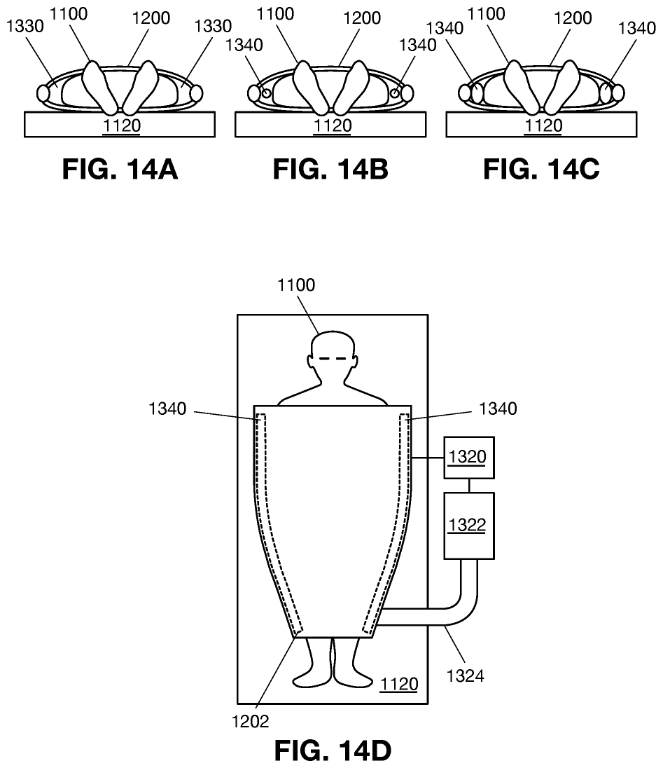

Apart from adjusting its closures 1210, an oversized wrap 1200 may be adapted to fit a person 1100 in other ways. FIG. 14A shows a person 1100 wrapped in an oversized wrap 1200, with interstitial spaces 1330 due to the size mismatch. FIG. 14B shows longitudinal inflatable bladders 1340 within the interstitial spaces 1330, in an uninflated state. FIG. 14C shows the bladders 1340 inflated to fill the interstitial spaces 1330. As shown in FIG. 14D, the bladders may be inflated using an air pump 1322 as previously discussed. Alternatively they may be inflated using gas cylinders (e.g. carbon dioxide). Optional controller 1320 may provide inflation control. The bladders 1340 may be incorporated in the wrap 1200 or separate. As an alternative to using inflatable bladders 1340, compressible inserts (e.g. foam) may be used.

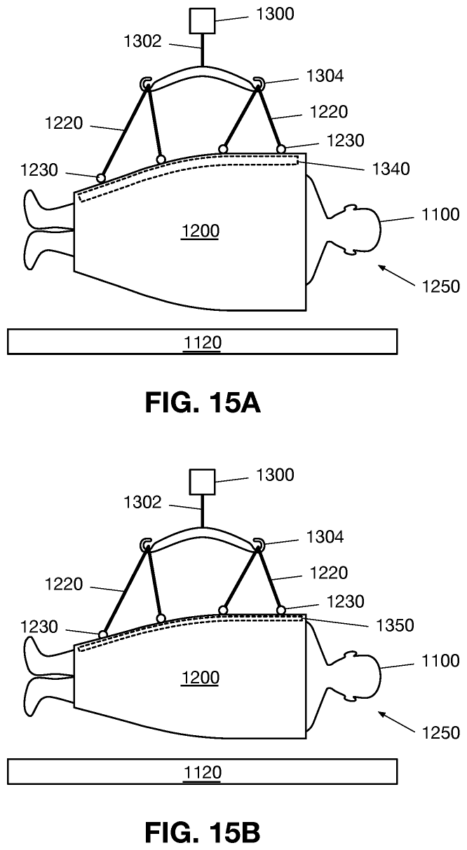

As shown in FIG. 15A, an inflatable longitudinal bladder 1340 may also be used to add rigidity to the wrap 1200, reducing the required number of attachment straps 1220 or the need for an intermediate support structure. And as shown in FIG. 15B, a permanently rigid part 1350 may also be incorporated in the wrap 1200 to provide rigidity. In both cases two such parts 1340 or 1350 can be provided, e.g. one in each wrap part 1202 and 1204, to provide rigidity along both lateral edges of the wrap 1200. The rigid part 1350 may be hinged to allow folding of the wrap part 1202 and 1204, and may be composed of tubular or solid steel, aluminium, carbon fiber, or other suitably rigid material.

When a person 1100 is in a prone position they are susceptible to pressure injuries to the face, and care staff generally need to perform a head check every few hours to forestall such injuries. A head check requires care staff to lift the person's head and shoulders, so can be quite onerous and can lead to injury to the care staff.

Wraps such as described in U.S. Pat. No. 11,357,685 (Beed), or the present wraps 1200, all of which are designed to be left (at least in part) under a person 1100 while in a prone position, can be used to easily perform a head check with the assistance of a lift.

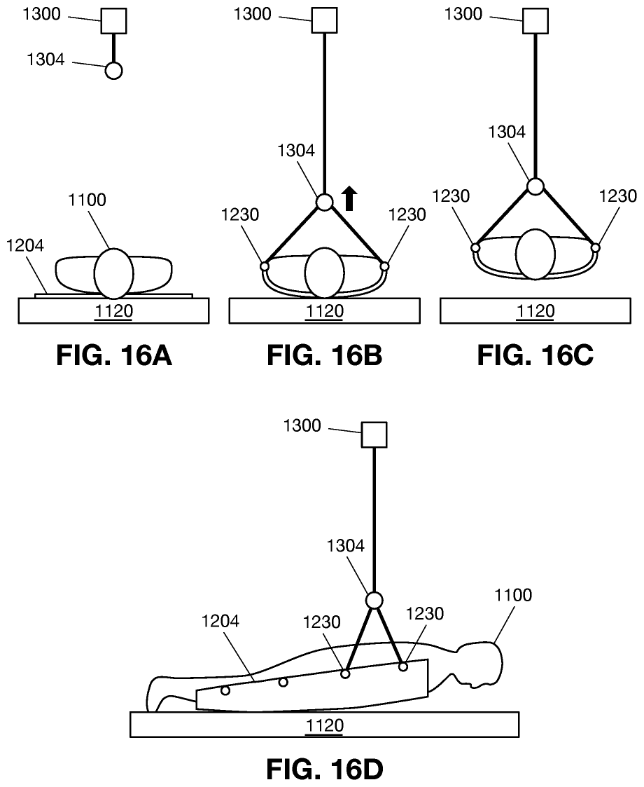

As shown in FIGS. 16A through 16D, the head and torso of a prone person 1100 can be partially lifted to allow a head check by attaching the front wrap part 1204 to a lift 1300 using one or more connection points 1230 on both lateral sides of the wrap part 1204, but using connection points 1230 towards the head end of the wrap part 1204 only.

As shown in the Figures, only the front wrap part 1204 is needed. The back wrap part 1202 can optionally be attached as well to securely cocoon the person 1100. If using a wrap such as described in U.S. Pat. No. 11,357,685 (Beed), the wrap would typically be securely closed before performing the head check lift.

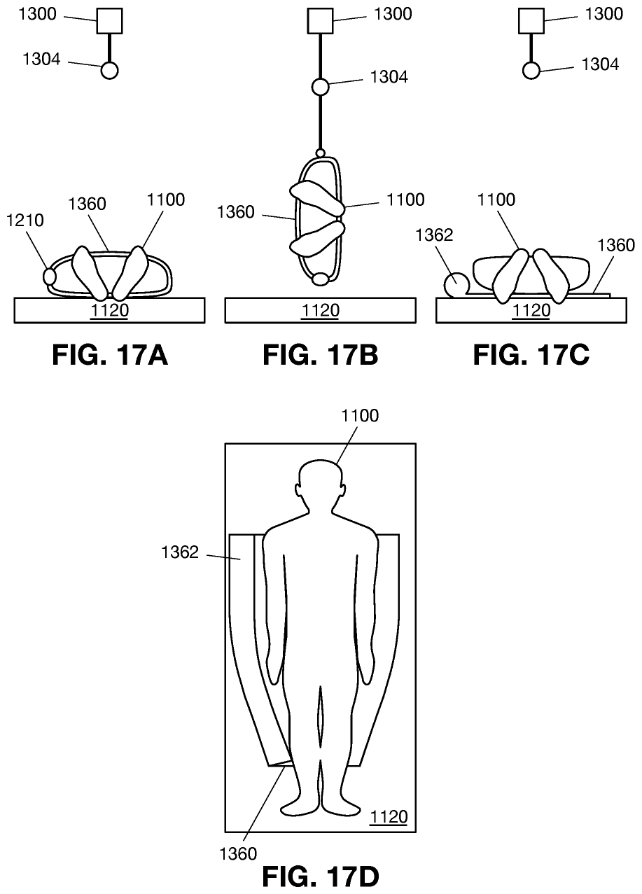

FIGS. 17A through 17D, a single-part wrap 1360 with a single closure assembly 1210 can be used in place of a two-part wrap 1200, providing many of the same affordances. As shown in FIG. 17C, when the wrap 1360 is open, the excess part 1362 of the wrap 1360 can be rolled up adjacent to the person 1100, and optionally secured using straps or hook-and-loop fasteners (not shown) incorporated in the wrap 1360.

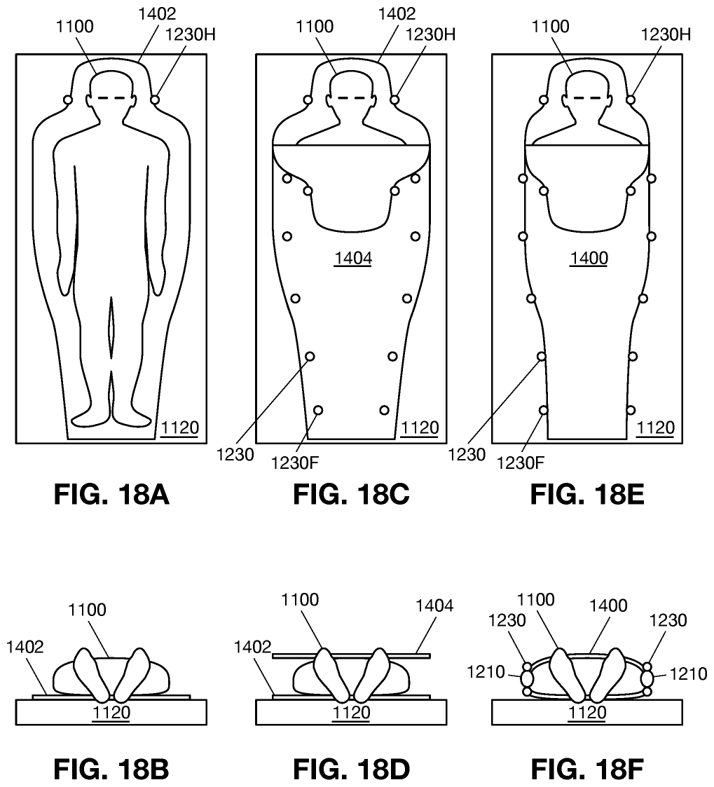

The wrap 1200 is shown in the Figures as extending from the shoulders to below the knees of the person 1100, and this is a practical minimum for supporting the use cases illustrated in the Figures and described herein. FIGS. 18A through 18F show a longer wrap 1400, extending from above the head to below the feet of the person 1100. The wrap 1400 comprises a back part 1402 and a front part 1404, back part 1402 being a longer version of back part 1202, and front part 1404 being a longer version of front part 1202.

The wrap 1400 may advantageously comprise additional connection points 1230H adjacent to the head of the person 1100, and connection points 1230F adjacent to the feet of the person 1100. Additional connection points 1230H in particular allow the head of the person 1100 to be supported by straps 1220 during a lateral transfer, as described in relation to FIGS. 5A through 5F. Also, when the wrap 1400 incorporates an air-assisted mechanism, as described in relation to FIGS. 13A and 13B, the wrap 1400 can provide the benefits of the air-assisted mechanism to the entire body of the person 1100 by virtue of supporting the entire length of the body of the person 1100.

The wrap 1400 may also comprise additional closures 1210 (not shown) adjacent to the head of the person 1100 and adjacent to the feet of the person 1100, allowing the person 1100 to be fully wrapped.

When the front wrap part 1404 is placed on top of the person 1100, as shown in FIG. 18C, the head-end part of the front part 1404 that would cover the face of the person 1100 can optionally be folded back, leaving the face exposed even when the person 1100 is wrapped, as shown in FIG. 18E. As the person 1100 is lowered into a prone position, the head-end part of the front part 1404 can be fully extended under the face of the person, and the head-end part of the back part 1402 can be folded back to expose the head of the person 1100 (and vice versa when transitioning from a prone to a supine position).

As described above, lateral transfer and proning procedures may advantageously take advantage of a lift 1300. However, in practice a lift may not be available. While ceiling-mounted lifts are increasingly well-represented in intensive care units, they are not yet prevalent in operating rooms. While a mobile lift may be used when a ceiling lift is not present, a mobile lift may itself not be available, and a mobile lift is typically not compatible with an operating table, i.e. the wheeled base of a mobile lift typically does not fit under or around the plinth of a typical operating table. Lateral transfers to imaging beds can be similarly challenging.

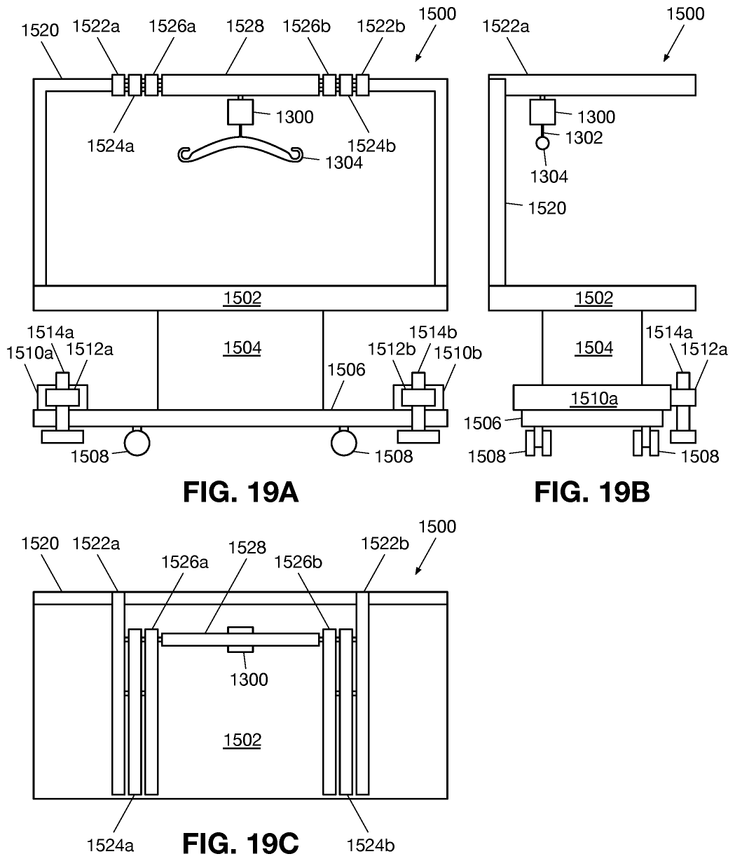

Another embodiment of the present invention then, as illustrated in FIGS. 19A through 19C, provides a wheeled hospital stretcher 1500 with an integral telescopic lift. The stretcher 1500 incorporates a telescopic frame for the lift, allowing the lift to extend its range to above an adjacent bed or operating table and the like. The stretcher 1500 additionally incorporates telescopic outriggers to stabilize the stretcher when the telescopic lift frame is extended.

Although described with reference to a hospital stretcher used to transport patients to and from an operating room, the stretcher 1500 (and variants thereof described below) may be a general hospital bed, and its lift 1300 may be used for general patient-handling tasks, including but not limited to lateral transfers.

Although the outriggers are shown extending from the base of the stretcher 1500, and rest on the floor when extended, the outriggers may alternatively extend from the bed of the stretcher and rest on an adjacent surface such as an operating table.

FIG. 19A shows a side elevation view of stretcher 1500; FIG. 19B shows an end elevation view; and FIG. 19C shows a plan view. The stretcher 1500 comprises a bed 1502, supporting plinth 1504, and base 1506 with four caster wheels 1508. The casters 1508 may be manually or automatically lockable.

The stretcher 1500 further comprises a lift support frame 1520, along one side of the bed 1502, to which a pair of fixed rails 1522a and 1522b are perpendicularly-mounted to extend above the bed 1502. Each fixed rail 1522a and 1522b supports a corresponding one of a pair of horizontally movable rails 1524a and 1524b, each movable rail 1524a and 1524b further supports a corresponding one of a pair of horizontally movable rails 1526a and 1526b, and movable rails 1526a and 1526b support a perpendicularly-mounted movable cross rail 1528 between them. Cross rail 1528 in turn supports a horizontally movable motorized lift 1300 with strap or cable 1302 and t-bar or hanger 1304.

The lift 1300 comprises a motor and drum, and the t-bar 1304 may comprise a swivel and detachable coupler, e.g. as described in U.S. Pat. No. 11,471,349 (Stevens), the contents of which are herein incorporated by reference thereto.

The stretcher 1500 further comprises a pair of outrigger rails 1510a and 1510b. Each outrigger rail 1510 supports a horizontally movable outrigger arm 1512, and each outrigger arm 1512 supports a vertically movable outrigger leg 1514.

The stretcher 1500 can also comprise components of a typical hospital stretcher such as a head board that is removable; a separate mattress; guard rails along the sides that may be lowered and/or removed; attachment sites for other equipment; a height adjustment mechanism for the bed 1502; a tilt adjustment mechanism for the bed or part of the bed (e.g. backrest); control interface(s) for motorized functions; microprocessor(s) and associated electronics for onboard control logic; etc. These are omitted for clarity. Typical hospital stretchers and beds are described in U.S. Pat. No. 3,304,116 (Stryker), U.S. Pat. No. 10,603,234 (Puvolgel), U.S. Pat. No. 11,116,683 (Connell), the contents of all of which are herein incorporated with reference thereto.

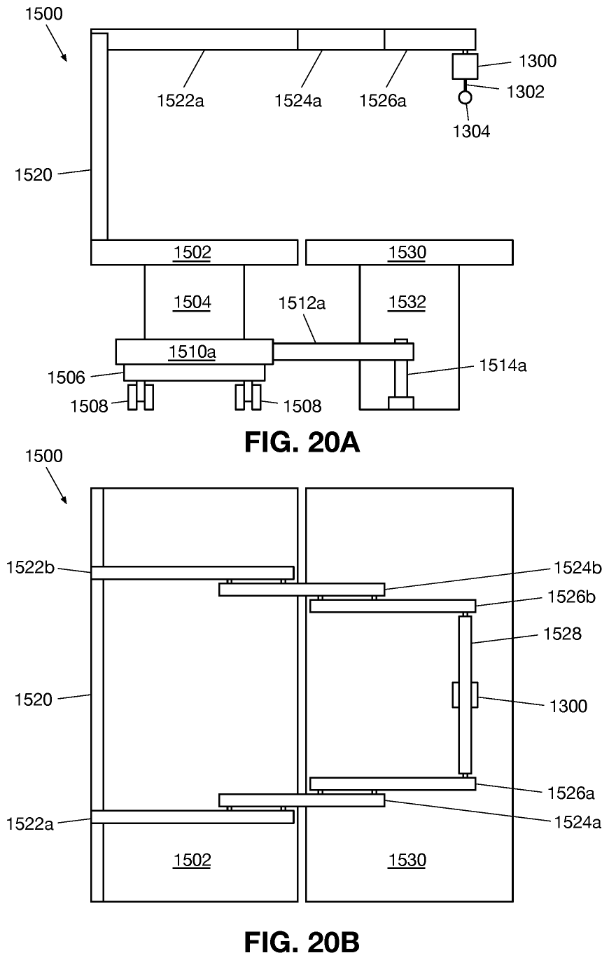

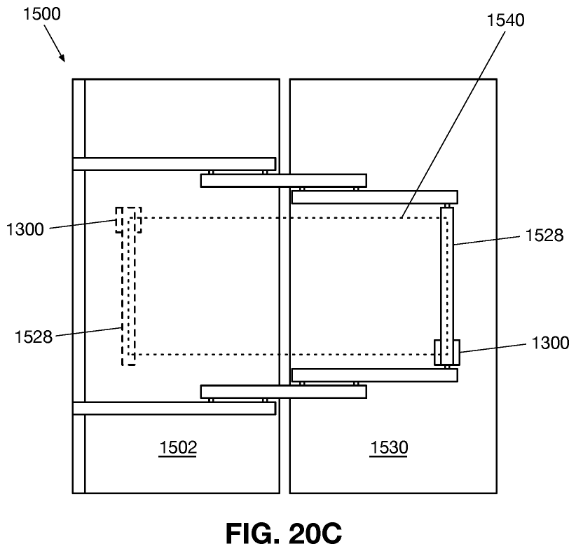

As illustrated in FIGS. 20A through 20C, the movable rails 1524 and 1526 may be extended above an adjacent surface, such as the surface of an operating table 1530, to provide lift 1300 with access to that surface. As shown in FIG. 20A, outrigger arms 1512 are extended and outrigger feet 1514 are lowered to stabilize the stretcher 1500 when the movable rails 1524 and 1526 are extended.

Movement of the outrigger arms 1512 and/or the outrigger legs 1514 may be motorized (motors not shown) or effected manually. The outrigger legs 1514 may be locked in an up or down position. Alternatively, each outrigger leg 1514 may have a caster wheel 1508 that is always touching the floor, and the outrigger leg 1514 may be fixed to its outrigger arm 1512.

Additional outriggers may be provided along the length of the base 1506 to ensure compatibility with a wider range of bed plinths and bases, i.e. a subset of outriggers may be utilized that do not interfere with an adjacent bed or other structure.

Movement of the movable rails 1524 and 1526 and the lift 1300 may be motorized (motors not shown) or effected manually, the latter being typical of most ceiling lift installations.

A rechargeable battery housed in the plinth 1504 or base 1506 powers all motors, including the motor of lift 1300. Power is delivered as required via rails 1522, 1524, 1526 and 1528, including to the lift 1300. A handheld wired remote control device (not shown) provides operator control of all motorized functions. A control panel (not shown) fixed to the stretcher may provide access to some functions.

When the movable rails 1524 and 1526 are in a retracted position, as illustrated in FIG. 19C, cross rail 1528 is close to the near side of the bed 1502, i.e. the side to which frame 1520 is attached. When the movable rails 1524 and 1526 are in an extended position, as illustrated in FIG. 20B, the cross rail 1528 is close to the far side of the adjacent surface (e.g. operating table 1530). As illustrated in FIG. 20C, since lift 1300 is movable along cross rail 1528, the stretcher 1500 provides the lift 1300 with full access to a two-dimensional area 1540 that spans the central portions of bed 1502 and its adjacent surface (e.g. operating table 1530).

The span of area 1540 provides full support for the in-situ proning, as discussed in relation to FIGS. 3A through 3L; lateral transfers as described in relation to FIGS. 5A through 5F; and lateral transfer with turning, as described in relation to FIGS. 6A through 6F. Longitudinal movement of the lift 1300 along cross rail 1528 allows the lift 1300 to be easily aligned with the center of mass of a patient 1100 (or wrapped patient 1250) being lifted. It also allows the longitudinal position of the patient 1100 to be adjusted during a lateral transfer.

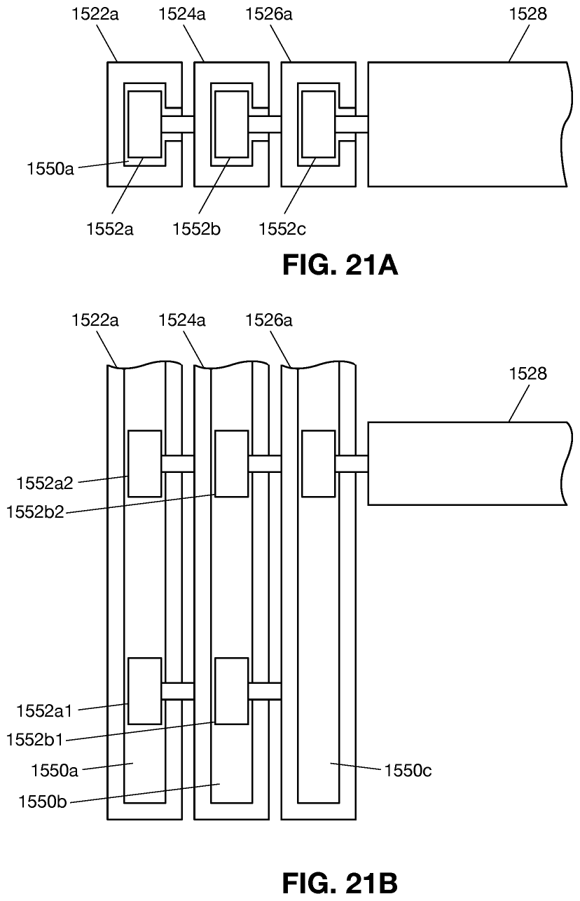

To minimise the required height of frame 1520, movable rails 1524, 1526 and 1528 all couple to each other horizontally rather than vertically. As shown in FIGS. 21A and 21B, each movable rail uses side-mounted trolleys 1552 that run in a cavity 1550 of its neighboring rail. Rails 1524 and 1526 use at least two spaced-apart trolleys 1552 to ensure a rigid overall structure with sufficient reach. Rail 1528, since it runs perpendicularly between rails 1526a and 1526b, uses a single trolley at each end. Although each trolley 1552 is shown comprising a single wheel, it may comprise any number of wheels in practice. The closed ends of each rail 1522, 1524, 1526 and 1528 act as stops for their respective trolleys.

The lift 1300 is coupled to the cross rail 1528 using a top-mounted trolley 1556 that runs in a cavity 1554 of the rail. Although the trolley 1556 is shown comprising a single pair of wheels, it may comprise any number of wheels or pairs of wheels in practice.

FIG. 21C shows an alternative embodiment of cross rail 1528, with the lift 1300 enclosed in the cavity 1554 to further reduce the required height of frame 1520.

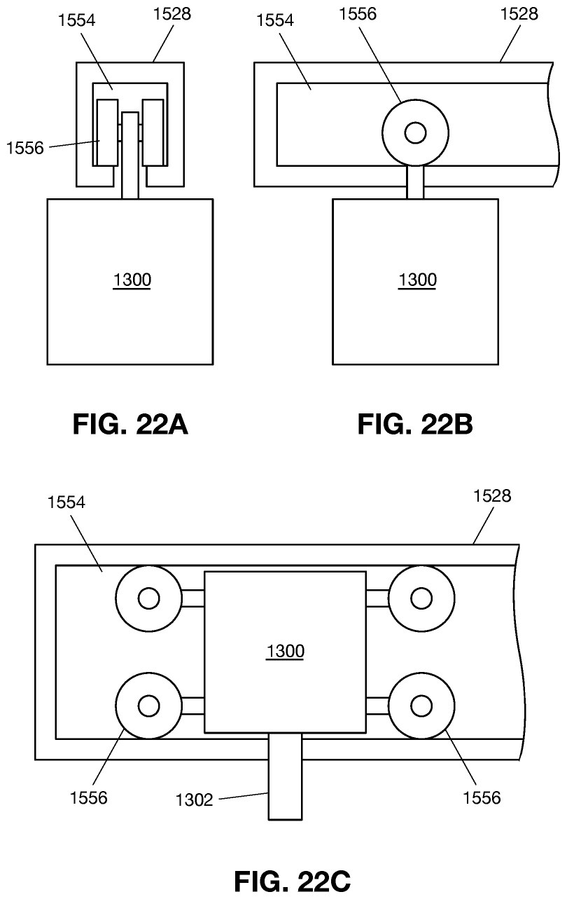

As an alternative to each movable rail using side-mounted trolleys 1552 to couple to its neighbor, some or all of the movable rails may utilise top-mounted trolleys (such as trolley 1556 described in relation to FIGS. 22A and 22B), at the expense of needing more headroom.

As a further alternative, each moveable rail may utilize a hybrid mechanism comprising top-mounted trolleys coupled laterally to their corresponding movable rail using u-shaped brackets, as disclosed in U.S. Pat. No. 7,413,394 (Risser), the contents of which are herein incorporated by reference thereto.

To minimise the height of frame 1520, e.g. during movement of the stretcher 1500 between rooms, the frame 1520 may be vertically lowerable relative to the bed 1502 when the lift 1300 is not in use. For example, each vertical post of the frame 1520 may be telescopic, or may be lowerable through the bed 1502. Alternatively or additionally, the bed 1502 may itself be lowered for this purpose, as described in relation to stretcher 1600 below.

Although illustrated with two movable rail pairs 1524 and 1526, stretcher 1500 may comprise fewer or more rail pairs of the same or similar design.

Stretcher 1500 may comprise additional structural components, not shown in FIGS. 19A through 19C, in order to minimise the required strength of its various components, including the strength of support frame 1520, fixed rails 1522, movable rails 1524 and 1526, and their various couplings.

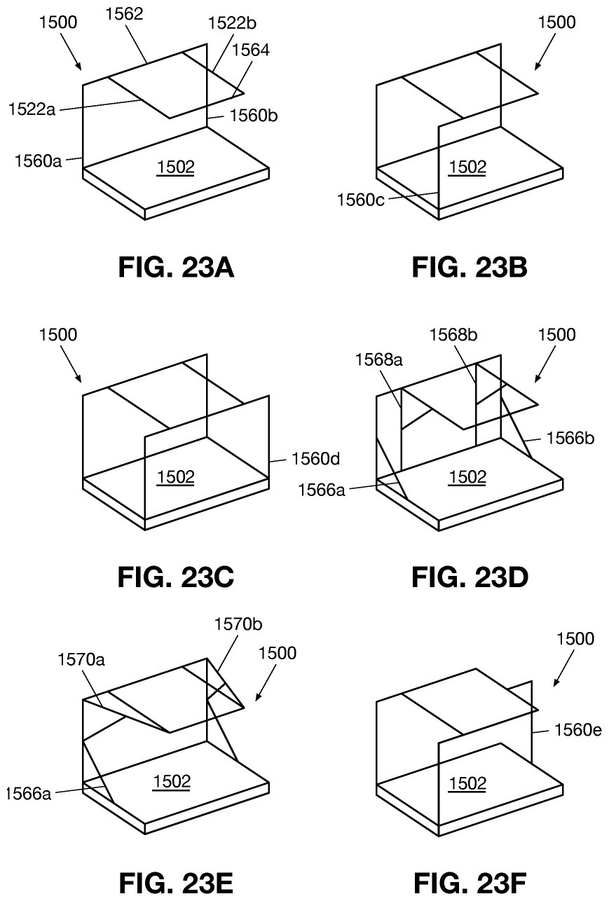

As shown in simplified form in FIG. 23A, support frame 1520 comprises a pair of vertical posts 1560a and 1560b, and a horizontal cross bar 1562 to which the fixed rails 1522 are mounted. Additional rigidity may be achieved by adding a cross bar 1564 joining the distal ends of the fixed rails 1522, and/or the distal ends of movable rails 1524, and/or the distal ends movable rails 1526.

In general, structural components of stretcher 1500 may be constructed from solid or tubular steel, aluminum or any other suitably rigid material.

As shown in FIG. 23B, a third post 1560c may be added at the foot end of the bed 1502 to increase rigidity; and as shown in FIG. 23C, a fourth post 1560d may be added at the head end, although this makes it more difficult to transfer an anesthetized patient.

As shown in FIG. 23D, struts 1566 may be used to support posts 1560, and strutted posts 1568 may be used to support fixed rails 1522. And as shown in FIG. 23E, strutted side braces 1570 may also be used to support fixed rails 1522.

As shown in FIG. 23F, a single support post 1560e may be centrally positioned at the head end, to facilitate transferring an anesthetized patient in either lateral direction.

Although the spacing of the fixed rails 1522 is shown as smaller than the spacing of the posts 1560a and 1560b, the spacing of the fixed rails 1522 may in practice be larger, including to the full length of the stretcher 1500.

Although the combination of a stretcher and lift is described herein as an integrated design, the lift frame 1520 may be detachable from the bed 1502, and may be attachable to a conventional stretcher or bed.

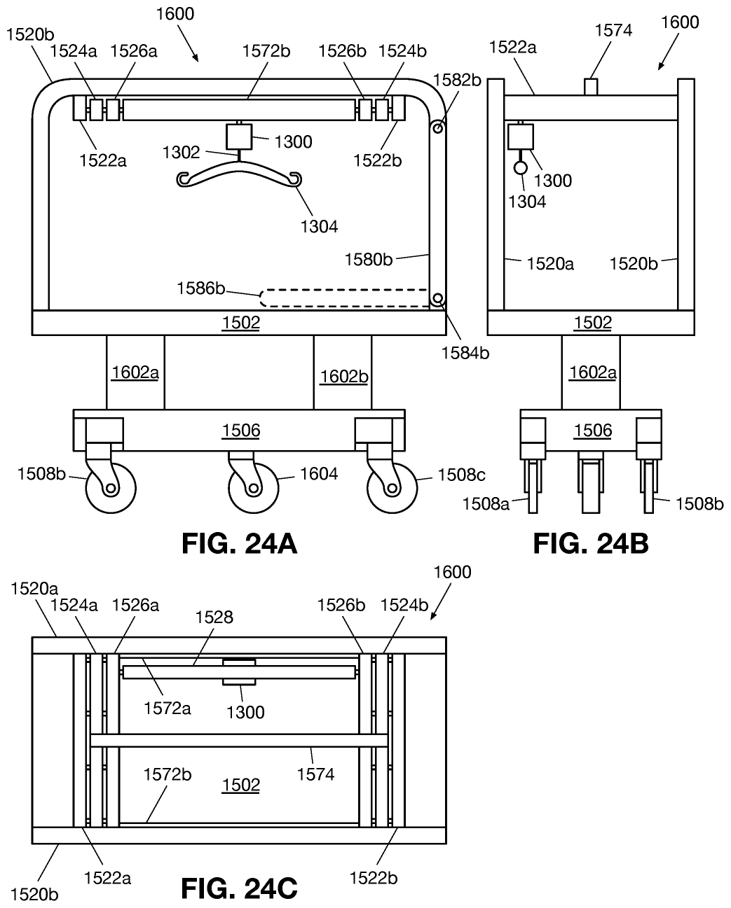

Transferring a patient onto or off the stretcher 1500 may be constrained to using a particular side of the stretcher, e.g. due to the configuration of an operating room. It is therefore advantageous to provide a stretcher 1500 that allows a patient to be transferred onto or off the stretcher from either lateral side. FIGS. 24A-24C illustrate a variant 1600 of the stretcher 1500 of FIGS. 19A-19C, refined to allow a patient to be transferred using the lift 1300 in either lateral direction.

The stretcher 1600 utilises two frame sections 1520a and 1520b, corresponding to the configuration shown in FIG. 23C. The two frame sections 1520a and 1520b are connected to the foot-end corners of the bed 1502, and are connected to the head-end corners of the bed 1502 via two fold-down posts 1580a and 1580b respectively. During a lateral transfer of a patient an appropriate one of the fold-down posts 1580a and 1580b, i.e. facing in the direction of lateral transfer, can be folded down, out of the way, to allow the patient's head to be continuously supported by care staff during the transfer, and to allow any tubes etc. attached to the patient to be transferred with the patient. When post 1580b is folded down (shown in outline as 1586b), post 1580a is left in place to continue supporting frame section 1520a, i.e. corresponding to the configuration shown in FIG. 23B. Similarly, when post 1580a is folded down, post 1580b is left in place to continue supporting frame section 1520b. Each post 1580a and 1520b has a corresponding latch 1582a and 1582b at its upper end where it couples to frame section 1520a and 1520b, and a corresponding hinge 1584a and 1584b at its lower end where it couples to the bed 1502. As an alternative to each post 1580a and 1580b being foldable down, they may instead be telescopically collapsible upwards or downwards. An interlock ensures that at least one post 1580 remains in place to support its corresponding frame section 1520 at all times.

As an alternative to folding down or otherwise decoupling a post 1580 during a lateral transfer of a patient, a post 1580 may be only temporarily decoupled for the purposes of transferring tubes etc. from one side of the post to the other immediately before a transfer, and then recoupled prior to the actual transfer. This ensures that both posts 1580 are in place when the patient is lifted, reducing the required load capacity of frame sections 1520 etc. In this case the interlock can ensure that the lift 1300 is not loaded unless both posts 1580 are in place.

In an alternative configuration, as illustrated in FIG. 23F, a frame section 1560e may be centrally positioned at the head end of the bed and coupled to fixed rail 1522b. The frame section 1560e may be fixed in place, or may be laterally movable towards either head-end corner of the bed 1502.

Elevators 1602a and 1602b provide height adjustment of the bed 1502, optionally including longitudinal tilt through unequal elevation. The elevators may be motorized or manually-operated.

An optional centrally-positioned fifth wheel 1604 provides any or all of: powered movement, steering, and braking. Casters 1508a through 1508c can also optionally provide any of these functions. See for example U.S. Pat. No. 6,256,812 (Bartow), U.S. Pat. No. 6,792,630 (Palmatier), and U.S. Pat. No. 10,905,612 (Derenne), the contents of all of which are herein incorporated by reference thereto.

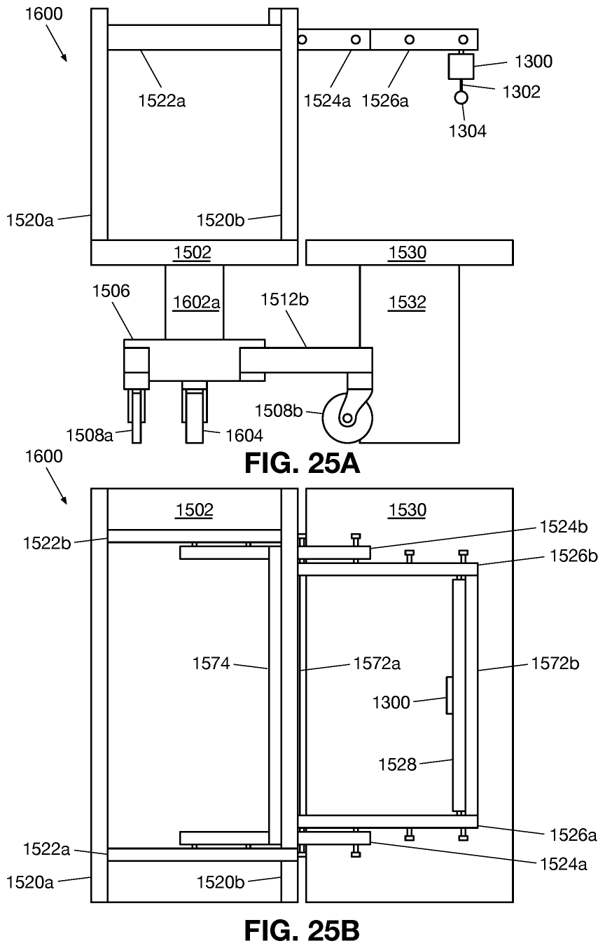

FIGS. 25A and 25B show the movable rails 1524a, 1524b, 1526a and 1526b of stretcher 1600 fully extended above an adjacent operating table 1530. Cross bars 1572a and 1572b provide additional stability to inner rails 1526a and 1526b. Optional cross bar 1574 provides additional stability to outer rails 1524a and 1524b.

Cross bar 1574 is mounted above outer rails 1524a and 1524b to allow inner rails 1526a and 1526b to move freely. Utilising a centrally-positioned cross bar 1574 allows it to also act as a stop for outer rails 1524a and 1524b, i.e. when it makes contact with frame sections 1522a and 1522b. This is discussed further below. Alternatively, two cross bars 1574, located at the ends of outer rails 1524a and 1524b, can provide additional stability, but require corresponding headroom below frame sections 1522a and 1522b to allow outer rails 1524a and 1524b to move freely.

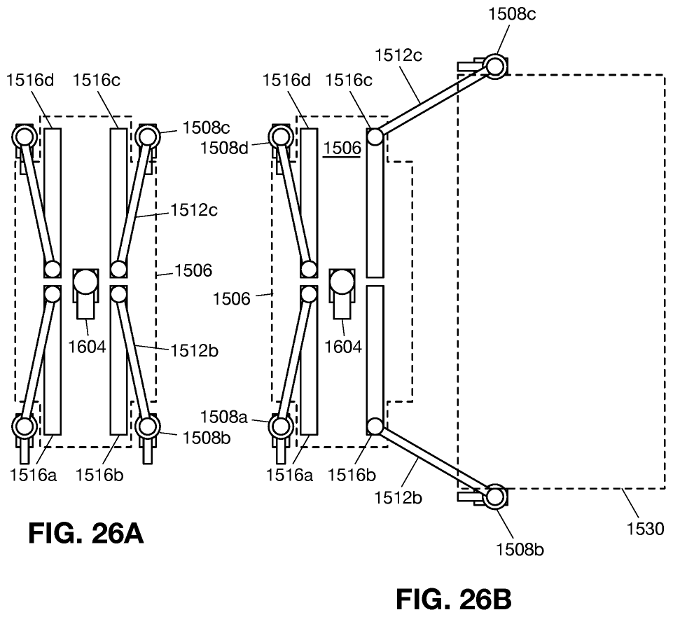

In place of the separate outrigger legs 1514a and 1514b of stretcher 1500, all four casters 1508a through 1508c are connected to corresponding extendable outrigger arms 1512a through 1512d, shown more fully in FIGS. 26A and 26B. The internal end of each outrigger arm 1512 runs in a corresponding track 1516. As before, pair-wise extension of outriggers may be motorized or performed manually (e.g. by pumping a foot pedal). To provide maximum clearance at either end of an adjacent structure such as an operating table 1530, outrigger arms (1512b and 1512c in FIG. 26B) are splayed apart when extended. Although shown as straight and monolithic, each outrigger arm 1512 may itself be articulated, telescoping, and/or curved.

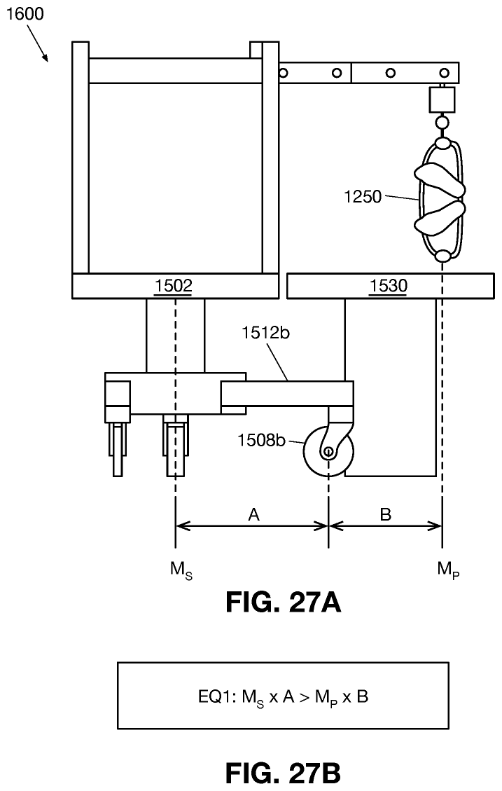

FIG. 27A shows an end elevation view annotated with variables used to calculate the lateral stability of the stretcher. The pivot point coincides with the point of contact of extended caster 1508b (and 1508c) with the floor. Variable A is the displacement of the center of mass of the stretcher 1600 from the pivot point. Variable B is the displacement of the center of mass of the patient 1250 from the pivot point. As shown in EQ1 in FIG. 27B, stability is achieved when the stabilizing moment, calculated as the product of the mass (Ms) of the stretcher 1600 and displacement A, exceeds the tipping moment, calculated as the product of the mass (Mp) of the patient 1250 and displacement B.

A larger stretcher mass (Ms) allows a larger patient mass (Mp) to be supported, per EQ1. Additional mass can be added to the stretcher 1600 to increase its load rating, modularly by end users or in the factory.

Stretcher 1600 can incorporate a force sensor (not shown) for determining the mass of any load attached to lift 1300, such as the mass of patient 1250. For example, the scale may be incorporated in lift 1300. Scales are a common option in hospital lifts, i.e. for determining patient mass for clinical purposes. Stretcher 1600 can further comprise control logic for determining whether (and/or how far) the load can be safely extended, and can prevent unsafe extension (e.g. via stops or brakes on the rails). The mass of the stretcher itself can be factory configured, user-configured, or automatically detected (e.g. via force sensors coupled to the casters, or by identifying the presence of tagged modular masses, e.g. via NFC or the like).

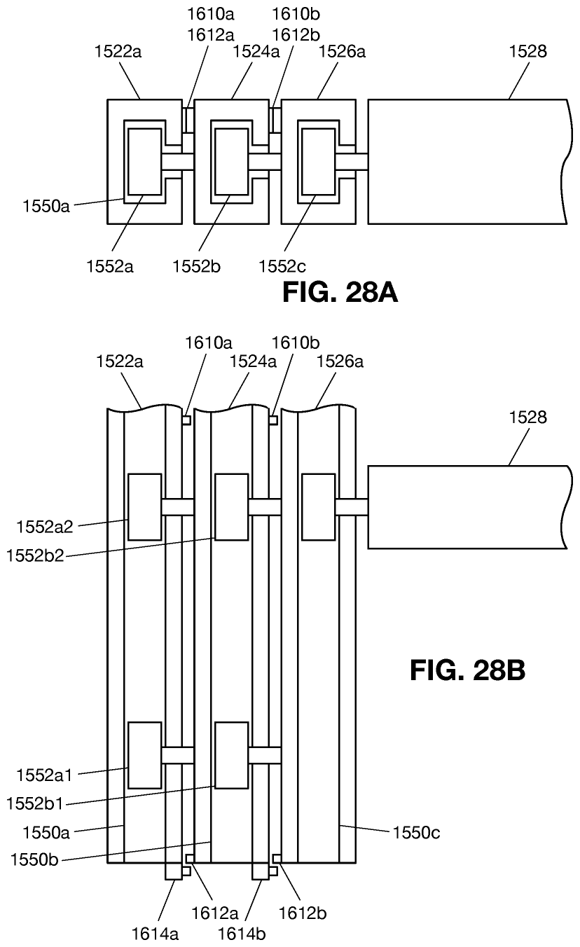

To allow the rails to be extended telescopically on either side of the stretcher 1600, each outer rail 1524 and inner rail 1526 comprises at least four trolleys 1552, so that at least two of the trolleys 1552 remain engaged with the rail's corresponding adjacent fixed rail 1522 or outer rail 1524 at all times. FIGS. 28A and 28B show cross sections of the telescopic rails of the stretcher 1600. Unlike the closed-ended rails shown in FIG. 21B, the rails in FIG. 28B are open-ended to allow trolleys 1552 to exit and re-enter the end of the rails as the rails are extended and subsequently retracted.

Center stops 1610a and 1610b on fixed rail 1522a and outer rail 1524a engage with end stops 1612a and 1612b on outer rail 1524a and inner rail 1526a respectively, to prevent the overlap of any two adjacent rails to become less than approximately 50%, i.e. to ensure that at least two trolleys 1552 of outer rail 1524 and inner rail 1526 remain engaged with the rail's corresponding adjacent fixed rail 1522 or outer rail 1524 at all times. End stops 1612 can be provided at both ends of each rail 1524a, 1524b, 1526a and 1526b, or just as minimally required. Likewise, retractable end stops 1614 can be provided on both ends of each rail 1522a and 1522b, or just as minimally required.

Center stop 1610a, end stop 1612a, and retractable end stop 1614a are not required if a centrally-positioned cross bar 1574 is connected across outer rails 1524a and 1424b, as previously described. Similarly, in the absence of cross bar 1574 (or in the presence of cross bars 1574 positioned at the ends of the rails) a centrally-positioned upwards-facing center stop can be provided on top of outer rails 1524a and 1524b to stop against frame sections 1520a and 1520b.

Extension of the telescopic rails in generally only required in one lateral direction at a time, and outrigger arms 1512 need only be extended on that side of the stretcher 1600 to provide stabilization. To prevent unsafe extension of the rails on the un-stabilized side of the stretcher, the rails can be prevented from being extended on the unsafe side. Retractable electromechanical end stops 1614a and 1614b can be provided at the ends of fixed rail 1522a and outer rail 1524a, engaging with end stops 1612a and 1612b to prevent telescopic extension of the rails on the unsafe side. A manual or electronic interlock can be provided whereby end stops 1614 remain extended and active until outrigger arms 1512 are extended on one side of the stretcher, at which time end stops 1614 can be retracted and thus deactivated on that side of the stretcher to allow extension of the rails. Retractable end stops 1614 can be provided at both ends of each rail 1522a, 1522b, 1524a and 1524b.

Any rail/trolley can in general incorporate a locking mechanism to prevent the corresponding movement. Locking is a common option in hospital lifts, e.g. to lock one axis of movement. The locking mechanism may be electromechanical or manual, and may act in aggregate to lock an entire axis of movement in a single operation, i.e. lateral movement of the lifting point and/or longitudinal movement of the lifting point.

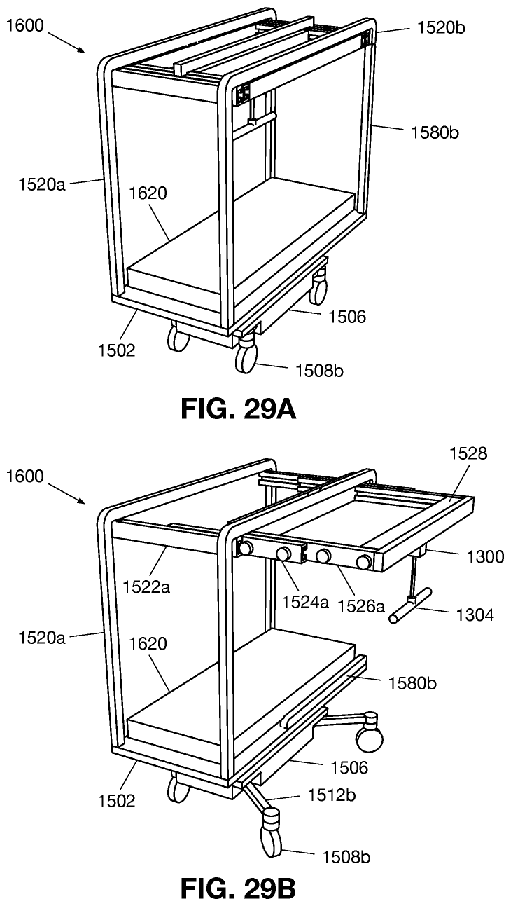

FIGS. 29A and 29B show perspective views of the stretcher 1600 with its telescopic rails retracted and extended respectively. FIGS. 29A and 29B also show a mattress 1620 positioned on top of bed 1502.

FIG. 29A shows fold-down post 1580b in a vertical position, supporting frame section 1520b, while FIG. 29B shows it folded down flush with the bed 1502, providing care staff with unimpeded access to the head of a patient during a lateral transfer.

The design of stretcher 1600 may be simplified by eliminating the outer movable rails 1524a and 1524b, and coupling inner moveable rails 1526a and 1526b directly to the fixed rails 1522a and 1522b. This results in a reduced range of lateral motion of the inner rails 1526a and 1526b, but can still provide the lift 1300 with a range that extends to the center of an operating table 1530 adjacent to the stretcher.

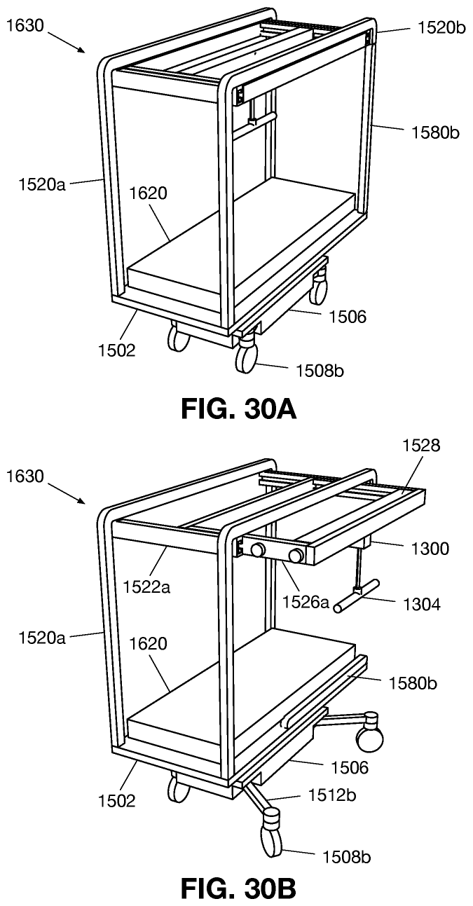

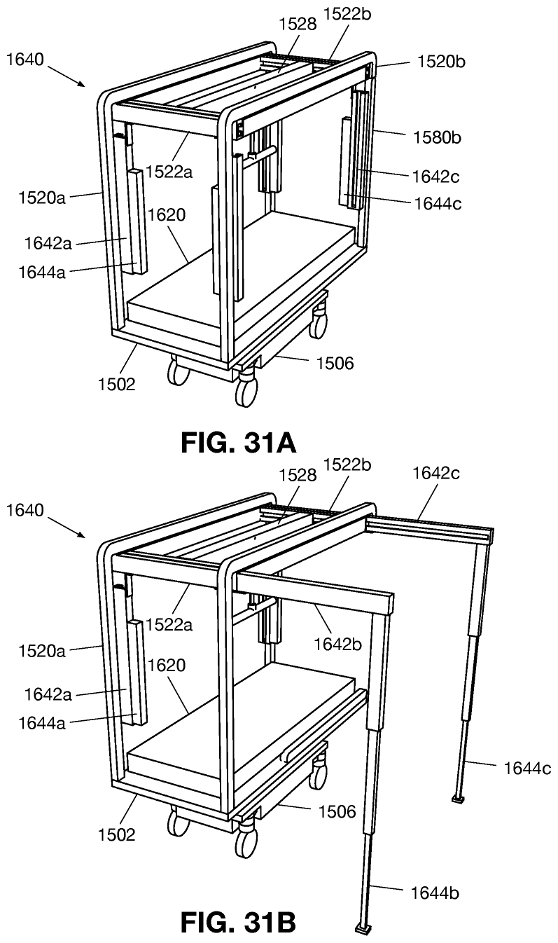

FIGS. 30A and 30B show a modified version 1630 of the stretcher 1600 with outer rails 1524a and 1524b eliminated in this way. FIGS. 30A and 30B show perspective views of the stretcher 1630 with its telescopic rails retracted and extended respectively.

As an alternative to (or in addition to) using outriggers to provide stability when the telescopic rails of the stretcher are extended and loaded, support posts may be provided that connect the telescopic rails to the floor. One or more support posts may be provided at any point along the length of a telescopic rail, including near or at the distal end of the rail, and including at any point along a cross bar joining two rails. Depending on their position relative to the load, support posts can reduce or eliminate the need for mass in the stretcher to provide a stabilizing counterweight to the load. If the posts are positioned beyond the furthest extent of the load then the need for a stabilizing counterweight is eliminated. Support posts are particularly useful for heavy loads, such as bariatric patients. A stretcher may incorporate both outriggers and support posts, and one or the other mechanism may then be deployed depending on a particular load. If outriggers are not provided, this simplifies the design of the base of the stretcher, and makes it easier to retrofit a lift to an existing stretcher design.

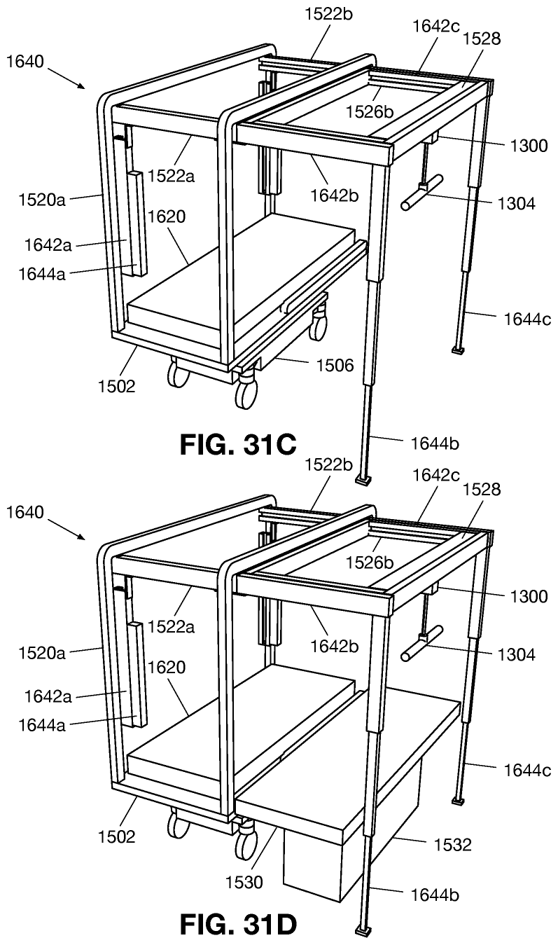

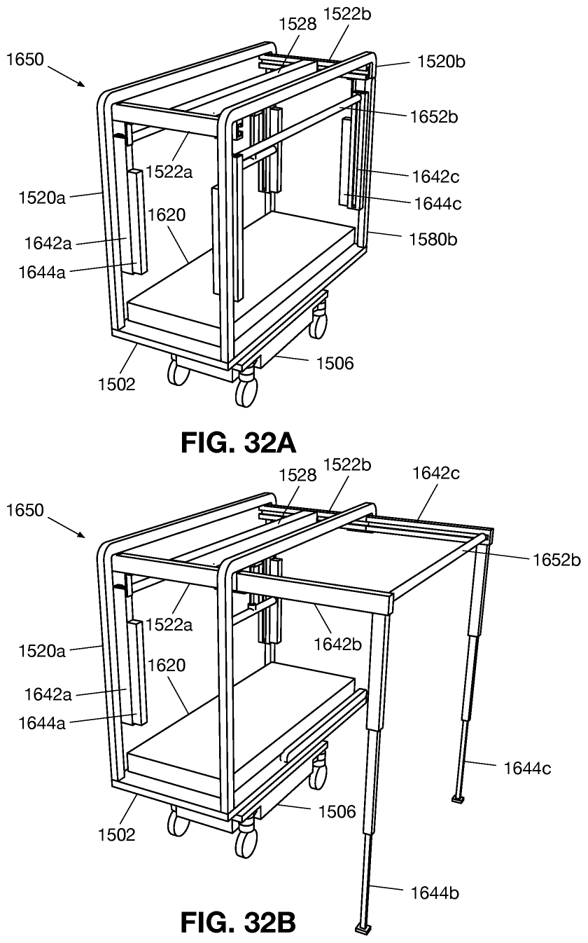

FIGS. 31A through 31D show a modified version 1640 of the stretcher 1630 with support posts provided in this way. Each fixed rail 1522 is augmented with a pair of extension rails 1642 that may be rotated into position to extend the range of the fixed rail 1522 laterally on either side of the stretcher 1640. An extension rail 1642 is connected near each end of each fixed rail 1522 via a hinge or the like. Each extension rail 1642 has a support post 1644, connected near the distal end of the extension rail 1642 via a hinge or the like. Each support post 1644 is telescopic to allow it to occupy minimum space when not in use. Alternatively each support post 1644 may be folding.

FIG. 31A shows a perspective view of the stretcher 1640 with all four of its extension rails 1642 folded out of the way, and each of its four support posts 1644 collapsed and folded out of the way adjacent to its corresponding extension rail 1642. FIG. 31B shows the extension rails 1642b and 1642c on one side of the stretcher 1640 rotated into position and extending their corresponding fixed rails 1522a and 1522b. Each extension rail 1642b and 1642c is supported by its corresponding support post 1644b and 1644c. FIG. 31C shows the inner movable rails 1526a and 1526b fully extended, as allowed by the extension rails 1642b and 1642c. The cross rail 1528 and lift 1300 are likewise shown at their furthest extension. FIG. 31D shows the same view as FIG. 31C, but with the operating table 1530 present to show the support posts 1644b and 1644c conveniently positioned beyond the operating table, thus providing lift access to the full width of the operating table 1530.

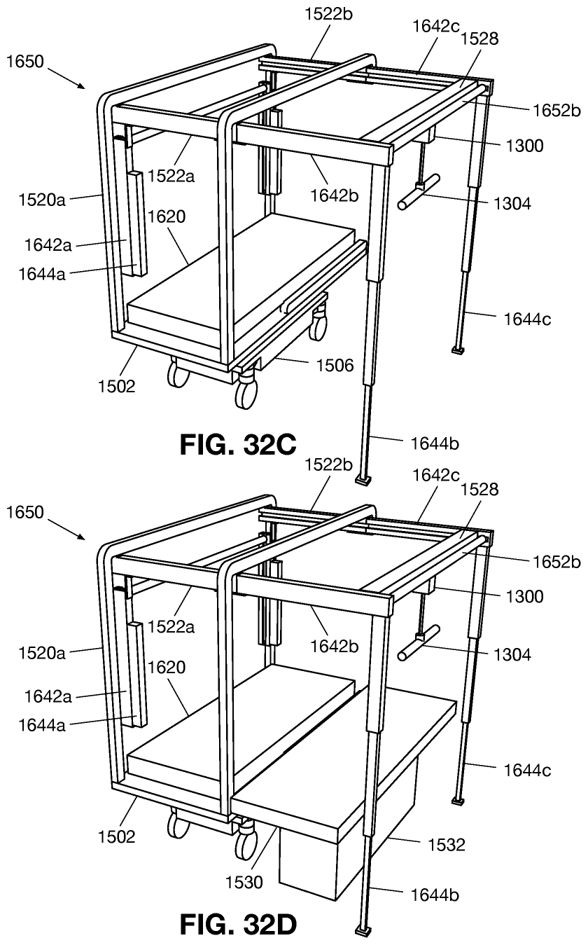

FIGS. 32A through 32D show a modified version 1650 of the stretcher 1640, with a movable cross bar 1652 between each pair of extension rails 1642 (e.g. cross bar 1652b between 1642b and 1642c).

While the cross bar 1652 may be fixed between the distal ends of the extension rails 1642, this may impede lateral access to the stretcher. Instead, as shown, the cross bar 1652 can be moveable along the length of the extension rails 1642, e.g. by coupling it to the existing cavities of the extension rails 1642, e.g. via trolleys. When a pair of extension rails 1642 is folded down and not in use, as shown in FIG. 32A, their cross bar 1652 may then be moved to the proximal ends of the extension rails 1642, i.e. towards the top of the corresponding lift support frame 1520. When a pair of extension rails 1642 are to be lifted into position, the cross bar 1652 can be slid towards the distal ends of the extension rails 1642 and used as a handle. FIGS. 32B through 32C show the extension rails 1642b and 1642c extended, and the cross bar 1652b positioned at the distal ends of the extension rails. A locking mechanism (not shown), e.g. coupled to the trolleys of the cross bar, can secure the cross bar at a given position along the extension rails 1642. The locking mechanism may conveniently be disengaged e.g. by a button positioned at the centre of the cross bar. Although each support post 1644 is shown connected to a corresponding extension rail 1642, one or more collapsible support posts 1644 may instead be connected along the cross bar.

Interlocks can be provided to prevent movement or loading of the lift 1300 beyond the footprint of the stretcher unless the appropriate extension rails 1642 are properly extended, and properly supported by their support posts 1644.

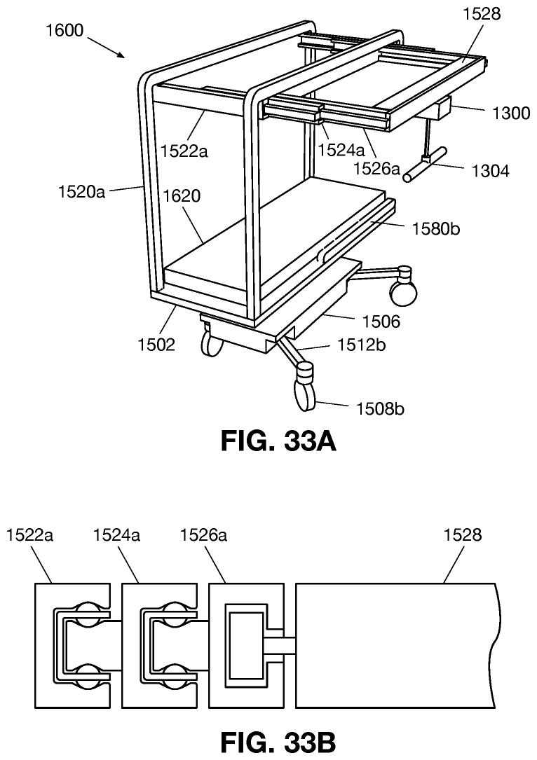

FIG. 33A shows a perspective view of the stretcher 1600 using ball bearing-based telescopic rails in place of trolley-based telescopic rails. FIG. 33B shows a corresponding side elevation view of a cross section of the rails of the stretcher 1600. As illustrated, bearing-based rails may be used for fixed rails 1522 and for outer rails 1524. Although not illustrated, bearing-based rails may also be used for inner rails 1526. And more generally, although illustrated with reference to stretcher 1600, bearing-based telescopic rails may be used in any stretcher previously described, including stretcher 1630, stretcher 1640, and stretcher 1650.

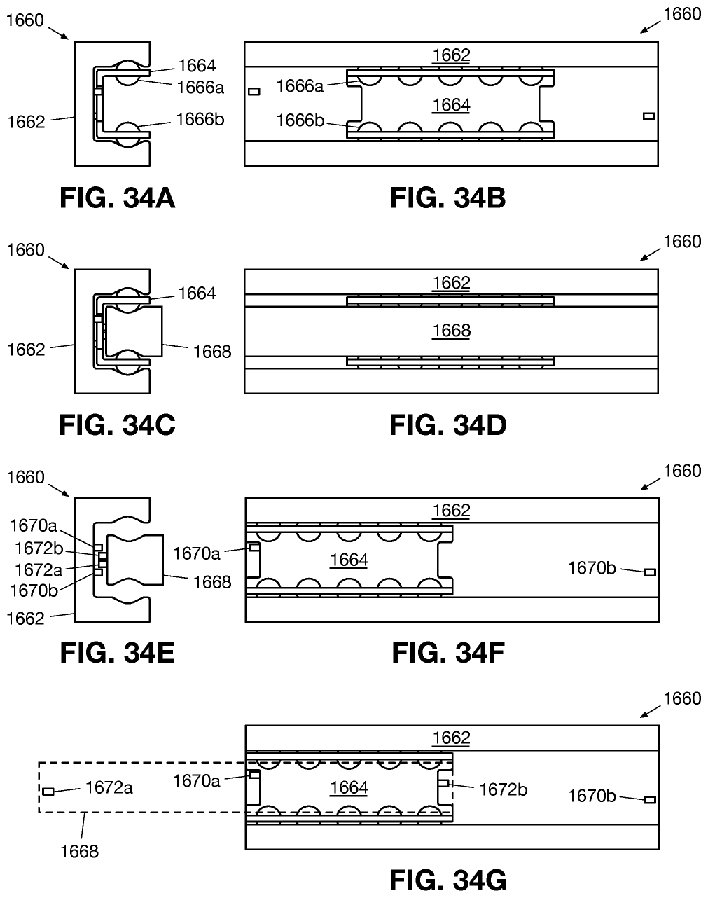

FIGS. 34A through 34D show a bearing-based telescopic rail 1660, e.g. as used for fixed rails 1522 and outer rails 1524. The rail 1660 comprises an outer rail member 1662 with a C-shaped cross section, a carriage 1664, a set of ball bearings 1666, and an inner rail member 1668. The outer rail member 1662 and inner rail member 1668 are coupled via the balls 1666, rolling along grooves in the two members. The carriage 1664 comprises a set of apertures along its length, each aperture acting to contain an individual ball 1666. By virtue of the coupling of the inner member 1668 with the outer member 1662 via the balls 1666, movement of the inner member 1668 over a particular distance results in movement of the carriage 1664 by half that distance in the same direction.

As shown in FIGS. 34E through 34G, end stops 1670a and 1670b may be provided to prevent movement of the carriage 1664 beyond the ends of the outer member 1662. Recesses in the carriage 1664 allow the end stops 1670 to be set back from the ends of the outer member 1662.

As also shown in FIGS. 34E through 34G, end stops 1672a and 1672b may be provided on the face of the inner member 1668, to prevent the inner member 1668 to move beyond its intended extension relative to either end of the outer member 1662. The vertical positions of end stops 1670 and end stops 1672 are staggered to allow them to move past each other. As previously discussed, actuated end stops may be provided to temporarily prevent inner member 1668 from being extended in either or both directions relative to outer member 1662. Such actuated stops can be positioned to engage with stops 1672.

The length of the carriage 1664 is chosen to equal the minimum overlap between the outer member 1662 and inner member 1668 at maximum extension. When the inner member 1668 is connected to a narrow member such as cross rail 1528 (i.e. which runs perpendicular to inner rails 1526 etc.), the minimum overlap is small and the carriage 1664 is correspondingly short.

Off-the-shelf telescopic rails (or slides) are available in a variety of designs, e.g. from Saibo (saibo-bearing.com). Full extension bi-directional designs include back-to-back (saibo-bearing.com/EN/d.asp?id=452) and H-type (saibo-bearing.com/EN/d.asp?id=492) designs. These may be used to implement a pair of telescopic rails 1660.

Rather than being mounted directly to the lift support frames 1520a and 1520b, an off-the-shelf telescopic rail may instead be mounted to an intermediate lateral member, itself mounted to the lift support frames.

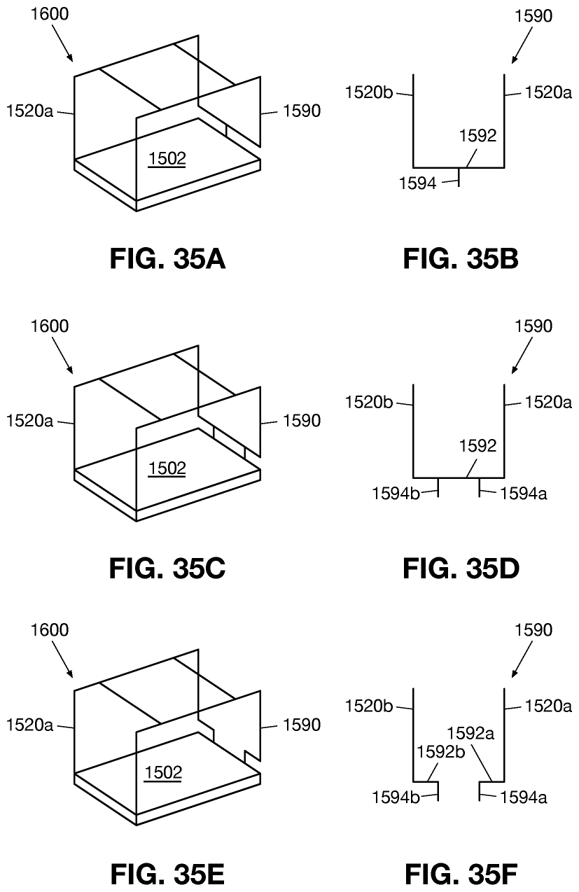

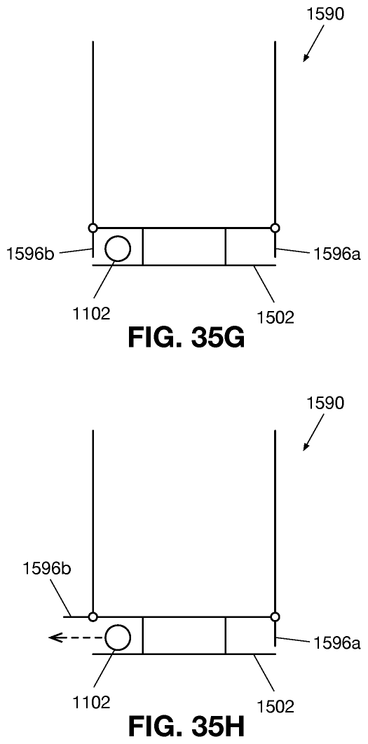

As previously discussed in relation to FIG. 23F, a single centrally-positioned head-end post can be used to eliminate the need for fold-down posts 1580a and 1580b, allowing tubes etc. connected to a patient to be easily transferred during a lateral transfer of the patient. FIGS. 35A through 35F illustrate variations of this approach, where two fixed head-end posts 1520a and 1520b are retained, but are supported by a cross bar 1592, positioned low enough to provide unimpeded access to the patient above the bar 1592, but high enough above the mattress 1620 to allow any tubes etc. connected to the patient to be positioned below the bar 1592 for easy lateral transfer. For example, cross bar 1592 may be positioned 10 cm above the top of mattress 1620. As shown in FIGS. 35A and 35B, cross bar 1592 may be supported by a single centrally-positioned post 1594. Alternatively, as shown in FIGS. 35C and 35D, cross bar 1592 may be supported by a pair of centrally-positioned posts 1594a and 1594b. Alternatively still, as shown in FIGS. 35E and 35F, cross bar 1592 may be split into two bars 1592a and 1592b, each supported one of the posts 1594a and 1594b. In either case, by way of example, posts 1594a and 1594b may be positioned a third of the width of the stretcher 1600 from the nearest edge of the stretcher.

In each case the head-end posts 1520, cross bar(s) 1592, and posts 1594 form a head-end post assembly 1590. Where the assembly 1590 is shown with right-angle joints in the simplified views, these may be implemented with a radius for strength.

Gates or other retention mechanisms can be provided to prevent tubes etc. from inadvertently sliding off the edge of the stretcher, especially during transport. As shown in FIGS. 35G and 35H, this can take the form of a pair of sprung gates 1596a and 1596b. FIG. 35G shows both gates in a closed position, with tube 1102 secured on top of the bed 1502. FIG. 35H shows the left gate 1596b in an open position, allowing tube 1102 to be transferred laterally.

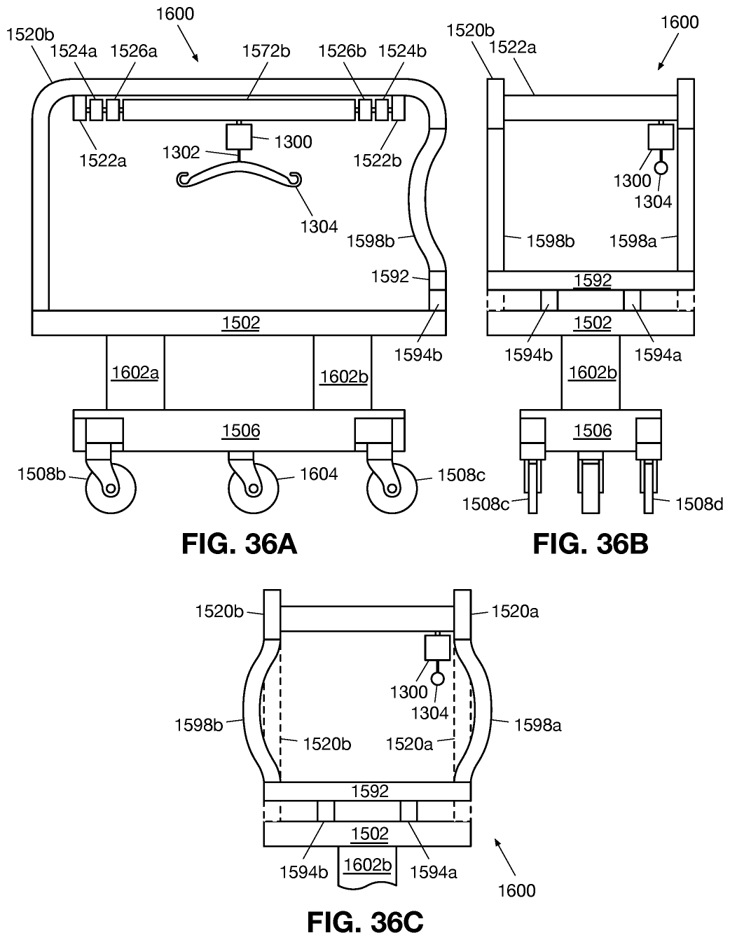

FIGS. 36A through 36C show the stretcher 1600 modified to use the head-post configuration shown in FIGS. 35C and 35D. In addition, stretcher 1600 is further modified so that the head-end post section of each lift support frame 1520a and 1520b is replaced by a bowed head-end post 1598a and 1598b that can swivel about the vertical axis. The bowed posts 1598 can be swiveled parallel to the stretcher 1600, as shown in FIGS. 36A and 36B, for easy passage through doorways etc. during transport, and can be swiveled perpendicular to the stretcher 1600, as shown in FIG. 36C, to provide clinical staff with improved access to the patient at the head end of the stretcher before or after transport.

The bowed posts 1598 can be allowed to swivel freely, or can be constrained to only swivel between the required parallel and perpendicular orientations. A locking mechanism, not shown, can allow the posts to be locked in a desired orientation. Alternatively or additionally, sufficient friction can be provided in the swivel joints to prevent inadvertent rotation without manual effort.

A lift of the kind embodied in the various stretchers (1600 etc.) described herein supports tasks beyond lateral transfers. It may, for example, be used to position, turn or boost a patient on a hospital bed or operating table or other surface, or to elevate a limb. Such a task does not require the integral bed of the stretcher, but may of course be performed in conjunction with a lateral transfer that does use the bed.

Where an integral bed is not required, it can be eliminated to allow clinical staff better access to the patient during a positioning task. Eliminating the integral bed also allows the lift to be used for lateral transfers to a wheelchair, and for mobilisation tasks such as sit-to-stand and gait training, optionally with weight relief provided via the lift.

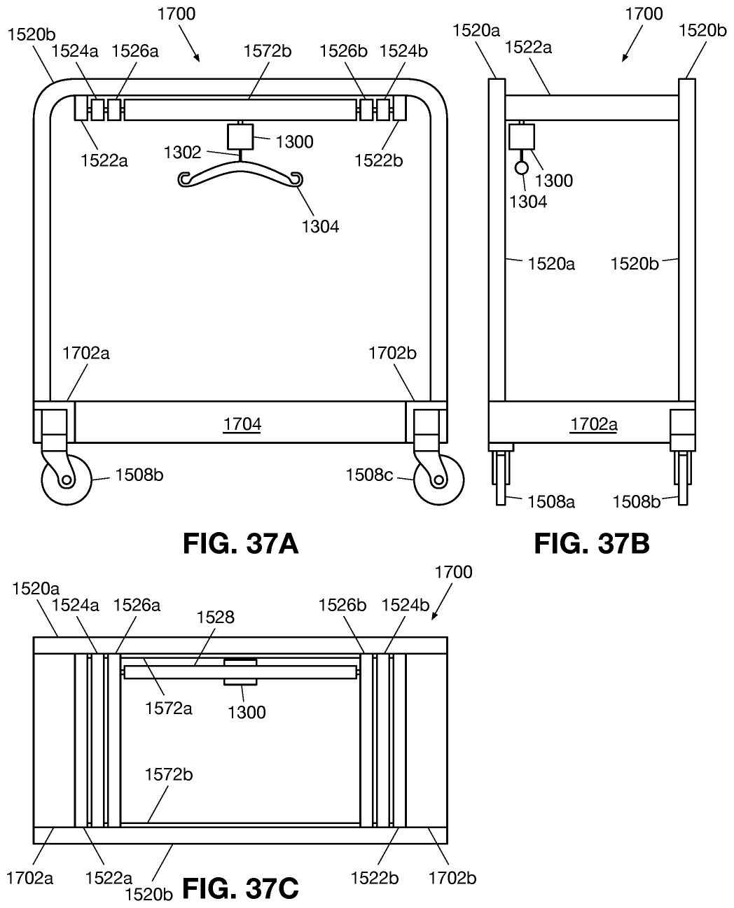

Another embodiment of the present invention then, as illustrated in FIGS. 37A through 37C, provides a mobile lift 1700 utilising the same lift mechanism as stretcher 1600 etc., but with no bed and an open base. Each lift support frame 1520a and 1520b extends down to the base, which comprises lateral members 1702a and 1702b, and an optional longitudinal member 1704 for rigidity. Like the stretcher 1600, the height of the mobile lift 1700 is chosen to maximise the operating headroom of the lift 1300, while fitting through a doorway. Furthermore, as with the stretcher 1600, the lift support frames 1520 can optionally be made adjustable in height.

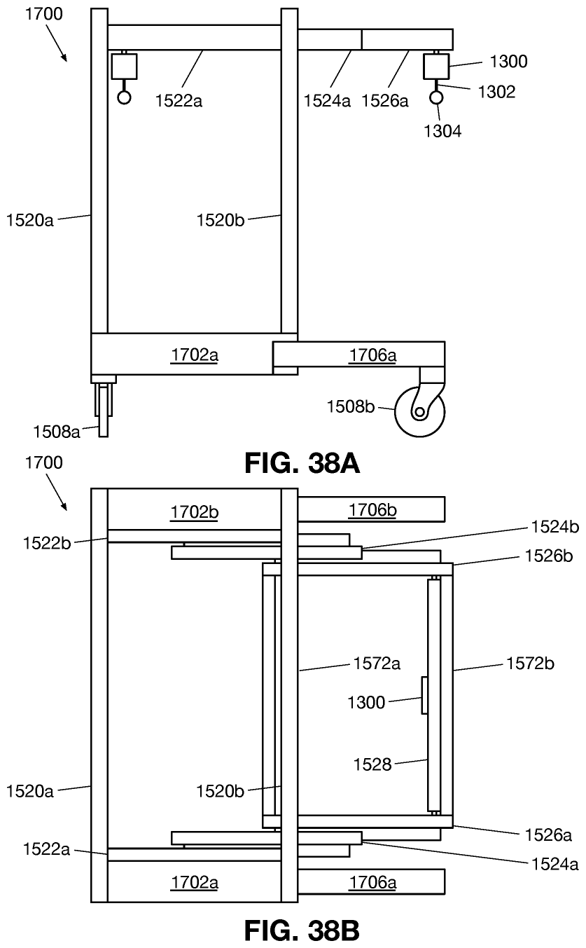

FIGS. 38A and 38B show the mobile lift 1700 fully extended. The mobile lift 1700 comprises a pair of telescopic outrigger arms 1706a and 1706b, housed within lateral members 1702a and 1702b. Each outrigger arm 1706a and 1706b is coupled distally to a corresponding caster 1508b and 1508c. Although not shown in detail, the outrigger arms may utilise the same telescoping mechanism as the lift, or similar. The mobile lift 1700 can also comprise outriggers that are separate from the casters, as discussed in relation to stretcher 1500. The outrigger arms 1706 may be motorized or manually operated.

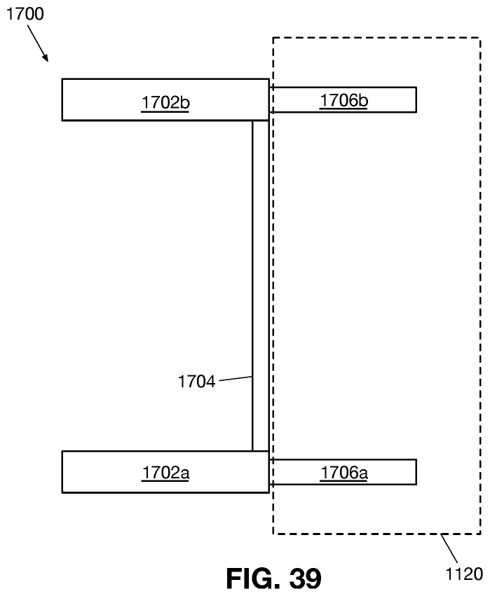

As shown in FIG. 39, the outriggers 1706 are designed to extend below an adjacent bed 1120. Longitudinal base member 1704, if present, is on the same side of the mobile lift 1700 as the outriggers, to allow unobstructed access to the floor area immediately under the mobile lift 1700.

The mobile lift 1700 can be configured to allow extension of the telescopic lift on only one side, like stretcher 1500, or on both sides, like stretcher 1600. FIGS. 37A through 39 illustrate a single-sided configuration.

Whereas the stretcher 1600 has a minimum required length in order to accommodate a patient, mobile lift 1700 may be the same length as stretcher 1600 or any desired shorter length, sufficient to support the required longitudinal movement range of the lift 1300 for a given set of tasks. The outriggers of a relatively shorter mobile lift 1700 may easily fit under an adjacent bed 1120, whereas a relatively longer mobile lift 1700, e.g. of a similar length to a bed 1120, can instead utilise outriggers that clear the ends of the bed 1120 if necessary, e.g. by emerging at an angle per stretcher 1600.

Since a mobile lift 1700 lacks the intrinsic mass of stretcher 1600 that incorporates a bed and base, mass may optionally be added to the base of mobile lift 1700 to increase its stabilizing moment, e.g. attached to lateral members 1702.

Although mobile lift 1700 is shown with telescopic outrigger arms 1706, these may also be fixed. If the outriggers are fixed, then the longitudinal dimension of the mobile lift can be adapted so it fits through a doorway, i.e. allowing the mobile lift to be oriented in a lateral direction rather than a longitudinal direction during transport.

Instead of or in addition to using outriggers, a stretcher 1600 (etc.) or mobile lift 1700 may be rigidly attachable or connectable to the side of a bed or operating table or other surface for stabilization during lifting.

Persons skilled in the art will appreciate that there are yet more alternative implementations and modifications possible, and that the above examples are only illustrations of one or more implementations.

1. An apparatus for supporting a person in a recumbent position and for repositioning the person, the apparatus comprising a platform for supporting the person, a wheeled base, and a motorised lift for elevating and repositioning the person, the platform having a longitudinal length sufficient to accommodate a length of the person and a lateral width sufficient to accommodate a width of the person.

2. The apparatus of claim 1 further comprising a frame, a pair of lateral tracks, and a longitudinal track, the frame extending upwards above the platform and coupled to the platform at or near its longitudinal ends, each lateral track coupled to a respective longitudinal end of the frame at or near a top of the frame, each end of the longitudinal track coupled a respective one of the lateral tracks via a trolley running along the lateral track, the lift coupled to the longitudinal track via a longitudinal trolley running along the longitudinal track, thereby allowing the lift to be moved freely both laterally and longitudinally relative to the platform, thereby allowing the person to be elevated using the lift and repositioned both laterally and longitudinally.

3. The apparatus of claim 2 further comprising a pair of lateral telescoping slides, each slide coupled to a respective longitudinal end of the frame at or near a top of the frame, each lateral track coupled to a respective slide, each lateral track thus coupled indirectly to the frame, each lateral slide adapted to telescope beyond at least one lateral edge of the platform, thereby allowing the person to be elevated using the lift and repositioned laterally between the platform and an adjacent support surface.

4. The apparatus of claim 3 further comprising a pair of telescoping outriggers, the outriggers adapted to telescope in the same direction as the slides, thereby to prevent the apparatus from tipping when the person is supported by the lift beyond a lateral edge of the platform.

5. The apparatus of claim 4 wherein the outriggers are coupled to the platform and are adapted to at least partially rest on the adjacent surface.

6. The apparatus of claim 4 wherein the outriggers are coupled to the base and are adapted to at least partially rest on a floor.

7. The apparatus of claim 6 wherein each outrigger comprises a wheel at or near its end.

8. The apparatus of claim 3 further comprising a wrap for at least partially wrapping the person and coupling the person to the lift.

9. The apparatus of claim 8 wherein the wrap comprises a first piece of flexible sheet-like material, the wrap adapted to be coupled to the lift via a plurality of straps connected along both of its lateral edges, and to support the person when elevated using the lift.

10. The apparatus of claim 8 wherein the wrap comprises a first piece of flexible sheet-like material and a second piece of flexible sheet-like material, the two pieces coupled to each other along both lateral sides of the person, the wrap adapted to be coupled to the lift via a plurality of straps connected along one of its lateral sides, and to support the person when elevated using the lift.

11. The apparatus of claim 3 further comprising at least one elevator, the platform coupled to the base via the at least one elevator, the at least one elevator adapted to allow the height of the platform relative to the base to be varied.

12. The apparatus of claim 3 wherein the frame comprises four vertical posts and two lateral horizontal bars, each post coupled to the platform at or near a respective corner of the platform, each lateral bar coupled to a pair of posts at or near a top of the posts at a respective longitudinal end if the frame.

13. The apparatus of claim 12 wherein the two posts at a head end of the platform are separated approximately by the width of the platform, but are inset along a bottom part of their height to allow one or more tubes connected to the person to be routed outside a respective one of the posts while allowing the one or more tubes to be routed inside a corresponding lateral edge of the platform.

14. The apparatus of claim 12 wherein the frame further comprises two longitudinal horizontal bars, each longitudinal bar coupled to a pair of the posts at or near a top of the posts along a respective lateral side of the frame.

15. A method, using the apparatus of claim 9, for repositioning the person from the platform to the adjacent surface, the method comprising the steps of: placing the first wrap piece on the platform; placing the person on top of the wrap piece; coupling both lateral edges of the wrap to the lift using straps; elevating the person using the lift; moving the suspended person to the adjacent surface; lowering the person onto the adjacent surface using the lift; and decoupling the wrap from the lift.

16. A method, using the apparatus of claim 10, for repositioning the person from the platform to the adjacent surface, the method comprising the steps of: placing the first wrap piece on the platform; placing the person on top of the wrap piece; placing the second wrap piece on top of the person; coupling the two wrap pieces together, thus at least partially cocooning the person; coupling one lateral side of the wrap to the lift using straps; elevating the person using the lift, thus simultaneously rotating the person approximately 90 degrees about a longitudinal axis of the person; moving the suspended person to the adjacent surface; lowering the person onto the adjacent surface using the lift, simultaneously rotating the person another approximately 90 degrees about their longitudinal axis; decoupling the wrap from the lift; decoupling the two wrap pieces from each other; and removing the first wrap piece.
